(19) United States
(12) Patent Application Publication
(10) Pub. No.: US 2026/0081646 A1
(43) Pub. Date: Mar. 19, 2026

(54) APPARATUS, SYSTEM, AND METHOD OF CONTROLLING TRANSMISSIONS VIA AN ANTENNA ARRAY ACCORDING TO A PLURALITY OF TRANSMISSION MODES

(71) Applicant: MobilEye Vision Technologies Ltd., Jerusalem (IL)

(72) Inventors: Ilia Yoffe, Hod-HaSharon (IL); Yossef Tsfati, Rishon Le Zion (IL); Adi Panzer, Tel Aviv (IL); Ofer Markish, Raanana (IL); Yaniv Avital, Mevaseret Zion (IL)

(73) Assignee: MobilEye Vision Technologies Ltd., Jerusalem (IL)

(21) Appl. No.: 19/286,767

(22) Filed: Jul. 31, 2025

Related U.S. Application Data
(60) Provisional application No. 63/696,800, filed on Sep. 19, 2024.
(60) Provisional application No. 63/742,685, filed on Jan. 7, 2025.

(51) Int. Cl. H04B 7/04; H04B 7/06

(52) U.S. Cl. CPC H04B 7/04013; H04B 7/0613

(57) ABSTRACT

For example, an apparatus may include a transmission controller configured to generate control signals to control transmissions via an antenna array according to a plurality of transmission modes, the plurality of transmission modes including a single-element transmission mode and a multi-element transmission mode. For example, the single-element transmission mode may include a plurality of single-element transmissions via a plurality of single-element antennas. For example, a single-element antenna may include a single antenna element of the antenna array. For example, the multi-element transmission mode may include a plurality of multi-element transmissions via a plurality of multi-element antennas. For example, a multi-element antenna may include two or more adjacent antenna elements of the antenna array. For example, a multi-element transmission via the multi-element antenna may include a simultaneous transmission via the two or more adjacent antenna elements.

### CROSS-REFERENCE

This application claims the benefit of and priority from U.S. Provisional Patent Application No. 63/742,685, entitled “APPARATUS, SYSTEM, AND METHOD OF CONTROLLING TRANSMISSIONS VIA AN ANTENNA ARRAY ACCORDING TO A PLURALITY OF TRANSMISSION MODES”, filed Jan. 7, 2025, and from U.S. Provisional Patent Application No. 63/696,800, entitled “APPARATUS, SYSTEM, AND METHOD OF A MULTI-MODE TRANSMISSION”, filed Sep. 19, 2024, the entire disclosures of which are incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of an antenna array, which may be implemented in accordance with some demonstrative aspects.

FIG. 12 is a schematic illustration of a single-element transmission scheme, in accordance with some demonstrative aspects.

FIG. 13A is a schematic illustration of a plurality of multi-element antennas based on antenna elements of an antenna array, in accordance with some demonstrative aspects.

FIG. 13B is a schematic illustration of a multi-element transmission scheme configured based on the plurality of multi-element antennas of FIG. 13A, in accordance with some demonstrative aspects.

FIG. 14A is a schematic illustration of a plurality of multi-element antennas and single-element antennas based on antenna elements of an antenna array, in accordance with some demonstrative aspects.

FIG. 14B is a schematic illustration a multi-element transmission scheme configured based on the plurality of multi-element antennas and single-element antennas of FIG. 14A, in accordance with some demonstrative aspects.

FIG. 15 is a schematic flowchart illustration of a method of controlling transmissions via an antenna array according to a plurality of transmission modes, in accordance with some demonstrative aspects.

FIG. 16 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

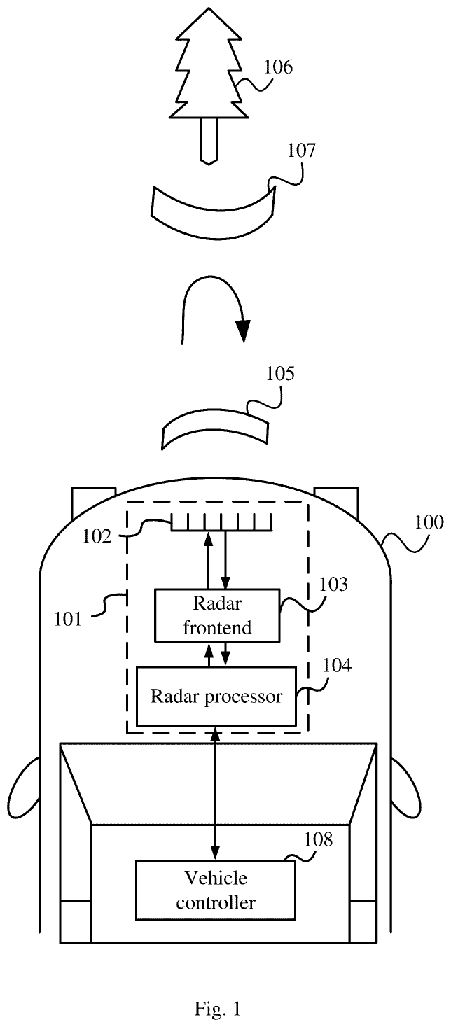

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

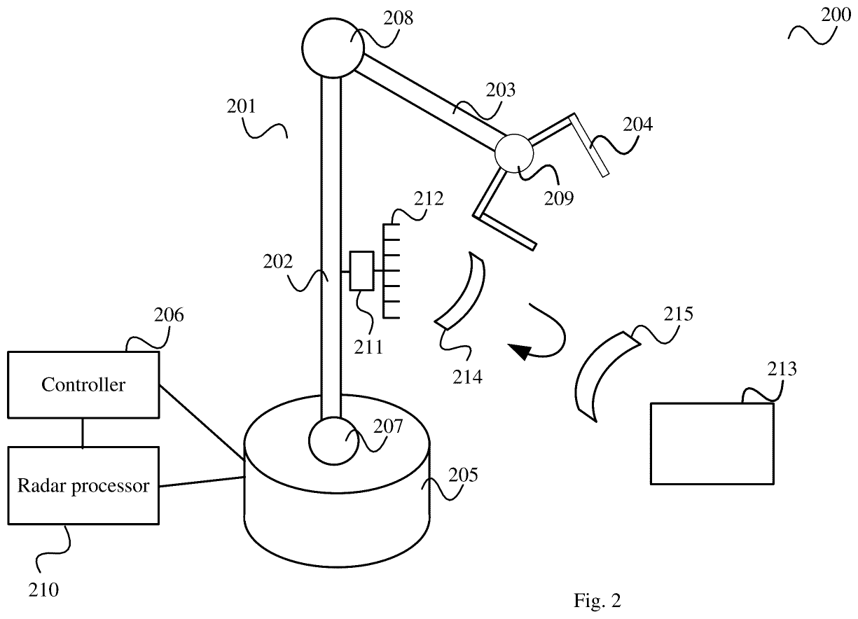

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

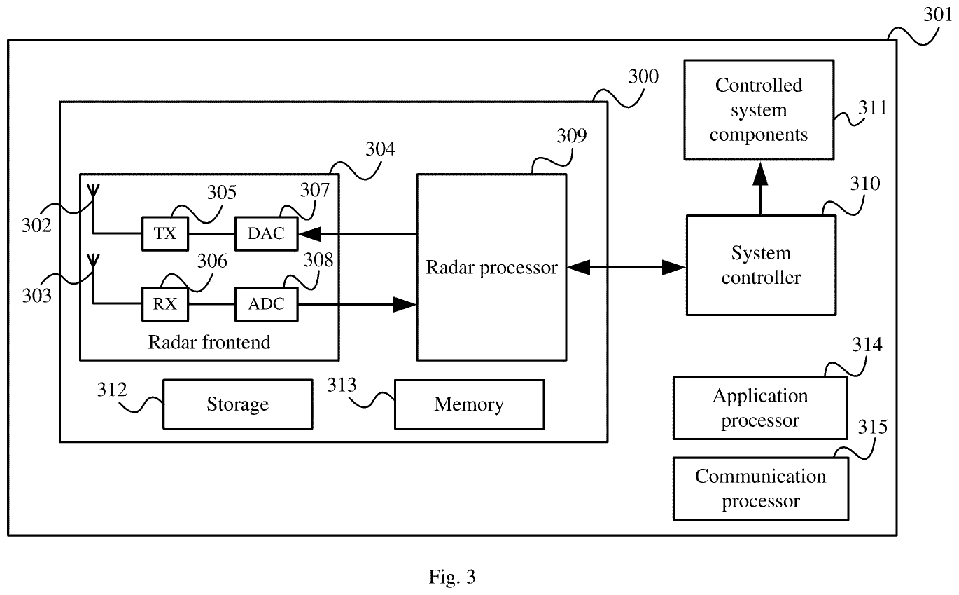

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may be configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

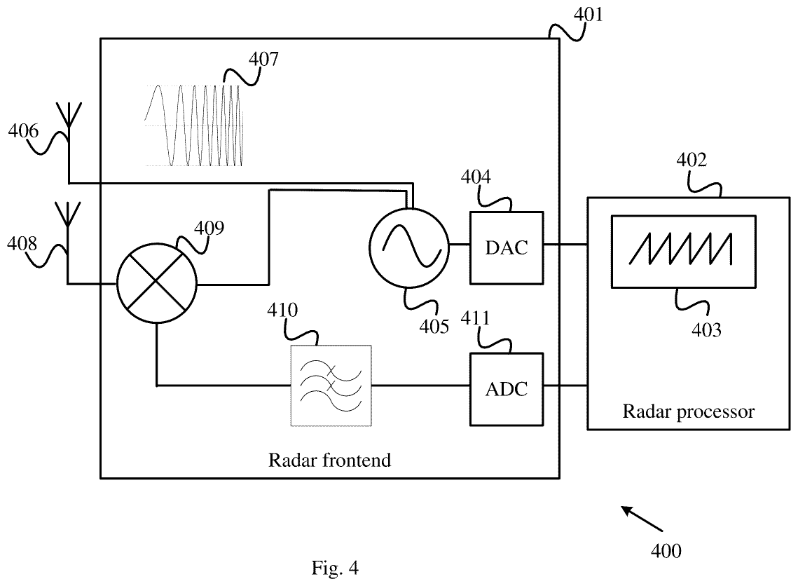

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

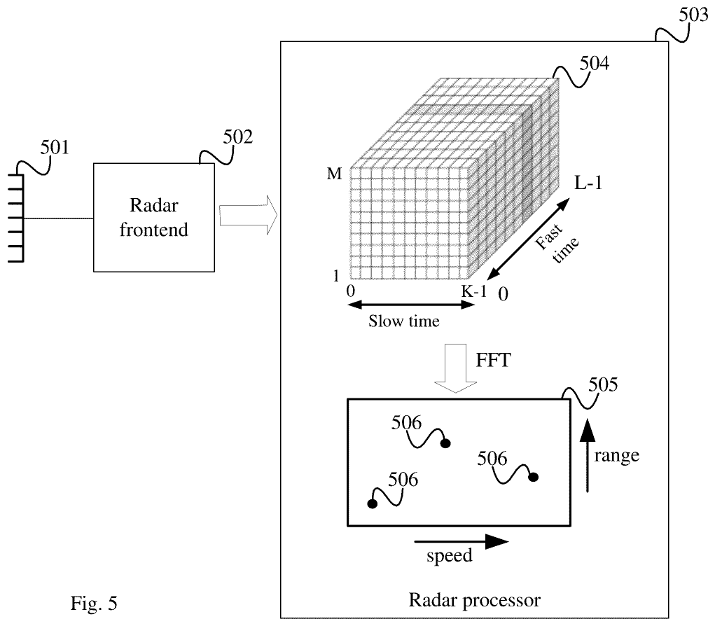

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, processor 503 may be configured to determine the range values, Doppler values, and/or Angle of Arrival (AoA) values, e.g., Azimuth values and/or Elevation values, for example, based on FFT techniques, e.g., as described below.

In other aspects, processor 503 may be configured to determine the range values, Doppler values, and/or Angle of Arrival (AoA) values, e.g., Azimuth values and/or Elevation values, for example, based on Super-Resolution (SR) techniques, and/or any other suitable processing technique.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

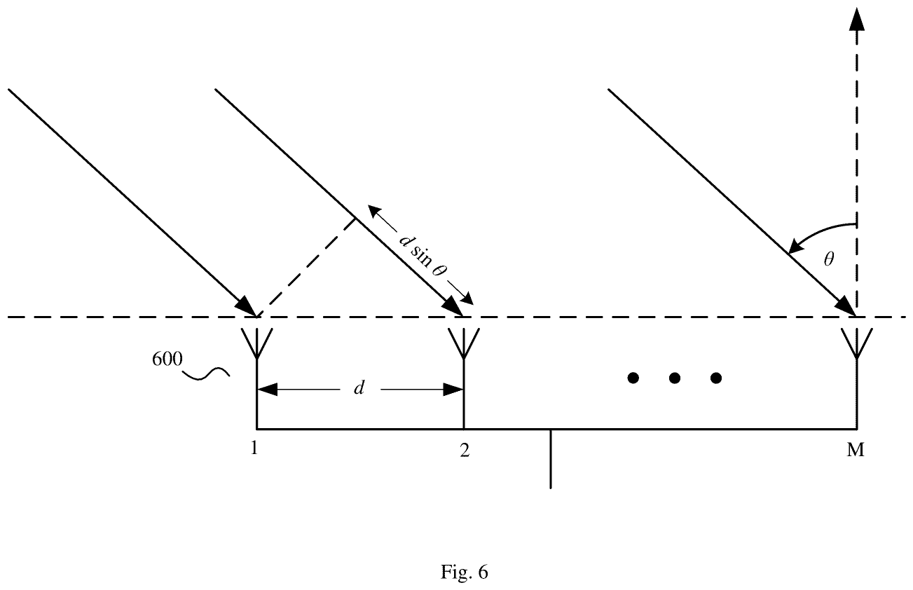

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

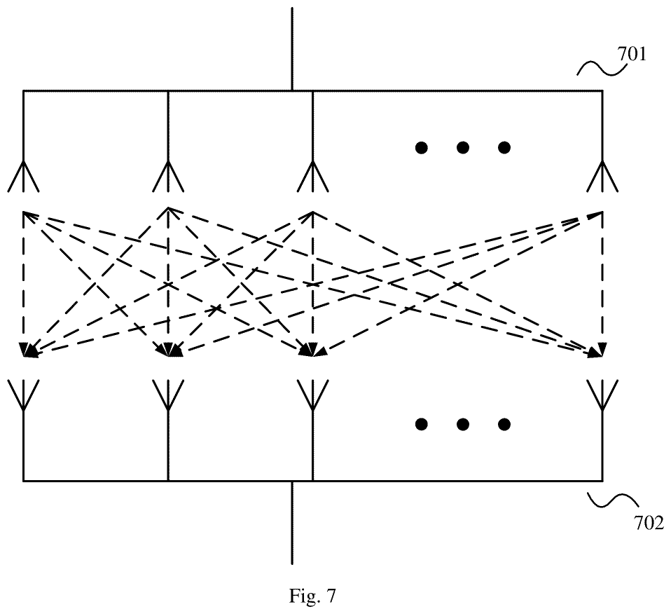

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

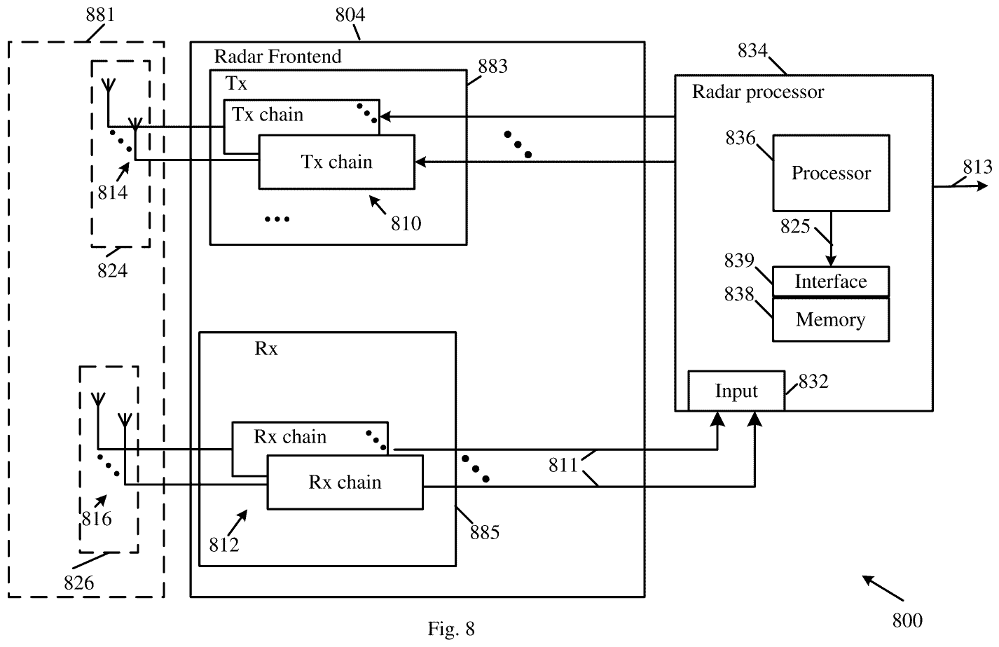

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

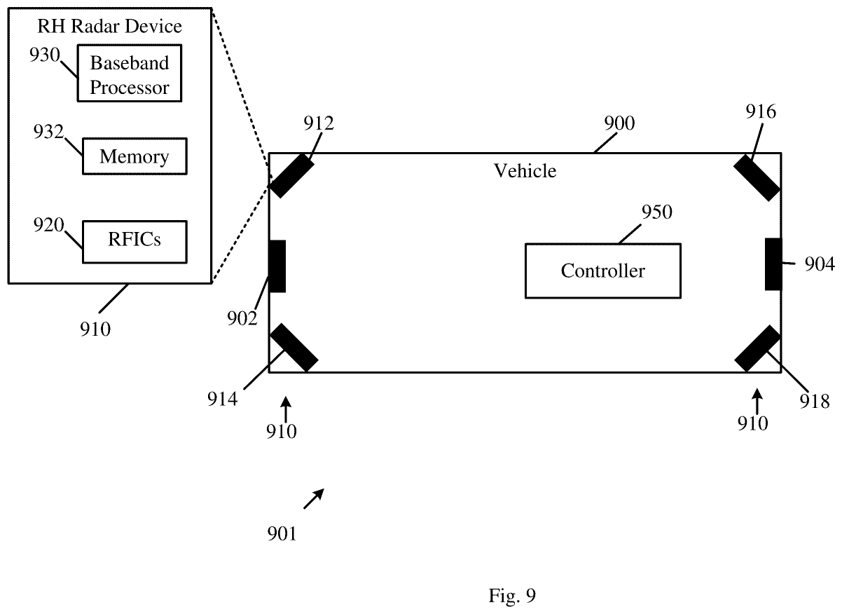

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to detect targets in a 4D space, e.g., including Range, Doppler, Azimuth (AZ), and Elevation (EL).

In some demonstrative aspects, a radar device, e.g., as described above with reference to FIGS. 1-9, may be configured to estimate the AZ and/or the EL of a detection, for example, based on one or more algorithms, e.g., Angle of Arrival (AoA) algorithms and/or any other suitable algorithms, which may be applied, for example to an input including spatial channels, e.g., antenna array signals, received by an antenna array of the radar device.

In some demonstrative aspects, radar performance of a radar device may depend on an element pattern of the antenna array implemented by the radar device. For example, the element pattern of the antenna element may be based on a directivity of the antenna element. For example, the element pattern may affect a Field of View (FoV) of the antenna array, and/or a gain of the antenna array.

In one example, an antenna array utilizing larger antenna elements may provide an increased directivity, e.g., an increased gain. However, the use of the larger antenna element may result in a narrower FoV of the antenna array. According to this example, there may be a tradeoff between the directivity of the antenna array and the FoV of the antenna array.

In some demonstrative aspects, a radar device, e.g., as described above with reference to FIGS. 1-9, may be configured to implement one or more operations and/or functionalities of a multi-mode transmission mechanism, which may be configured to support a plurality of transmission modes via an antenna array, e.g., as described below.

In some demonstrative aspects, the multi-mode transmission mechanism may be implemented, for example, to provide a technical solution to support multiple FOVs, and/or multiple antenna gains of an antenna array, for example, using the same hardware, e.g., the same antenna elements of the antenna array, e.g., as described below.

In some demonstrative aspects, the plurality of transmission modes may be configured to support a plurality of different FOVs, and/or a plurality of different antenna gains, which may be configured for the antenna array, e.g., as described below.

In some demonstrative aspects, the multi-mode transmission mechanism may be implemented, for example, to provide a technical solution to support switching, e.g., in an easy and/or efficient manner, between the plurality of transmission modes, e.g., as described below.

In some demonstrative aspects, the multi-mode transmission mechanism may be implemented, for example, to provide a technical solution to maintain substantially the same spacing between the antenna elements of the antenna array, for example, with respect to the plurality of transmission modes, e.g., as described below.

In some demonstrative aspects, the ability to maintain substantially the same spacing between the antenna elements may provide a technical solution to support substantially the same ambiguity properties of the antenna array, for example, in the plurality of transmission modes.

In some demonstrative aspects, the ability to maintain substantially the same spacing between the antenna elements may provide a technical solution to simplify processing algorithms for processing data according to the plurality of transmission modes.

In some demonstrative aspects, there may be one or more technical problems, disadvantages, and/or inefficiencies in an implementation of a “fixed” antenna array with a “fixed” configuration of antenna elements.

In one example, the fixed antenna array with the fixed configuration of the antenna elements may not be able to support changing an element pattern.

In some demonstrative aspects, there may be one or more technical problems, disadvantages, and/or inefficiencies in an implementation of a switched antenna array with switched antenna elements.

In one example, the switched antenna array with the switched antenna elements may require more space on a Printed Circuit Board (PCB), for example, to implement multiple antenna elements for a single Tx channel.

In some demonstrative aspects, a radar device, e.g., as described above with reference to FIGS. 1-9, may be configured to perform one or more operations and/or functionalities of a multi-mode transmission mechanism, which may be configured, for example, to provide a technical solution to support two or more transmission modes via the same antenna array, e.g., as described below.

In some demonstrative aspects, the multi-mode transmission mechanism may be configured, for example, to provide a technical solution to support a single-element transmission mode, at which a plurality of single-element transmissions may be transmitted via a plurality of single-element antennas of an antenna array, respectively, e.g., as described below.

In some demonstrative aspects, a single-element antenna may include a single antenna element of the antenna array, e.g., as described below.

In some demonstrative aspects, a single-element transmission via the single-element antenna may include a transmission via the single antenna element of the antenna array, e.g., as described below.

In some demonstrative aspects, the single-element transmission mode may be configured, for example, to provide a technical solution to support a wide FoV, and/or a low directionality for the antenna array, e.g., as described below.

In some demonstrative aspects, the multi-mode transmission mechanism may be configured, for example, to provide a technical solution to support a multi-element transmission mode, at which a plurality of multi-element transmissions may be transmitted via a plurality of multi-element antennas of the antenna array, e.g., as described below.

In some demonstrative aspects, a multi-element antenna may include two or more adjacent antenna elements of the antenna array, e.g., as described below.

In some demonstrative aspects, a multi-element transmission via the multi-element antenna may include a simultaneous transmission via the two or more adjacent antenna elements of the antenna array, e.g., as described below.

In some demonstrative aspects, a multi-element transmission via the multi-element antenna may include a transmission of a same signal, e.g., the same waveform, via the two or more adjacent antenna elements of the antenna array, e.g., as described below.

In some demonstrative aspects, the multi-element transmission mode may be configured, for example, to provide a technical solution to support a more directed array, for example, an array having a narrower FoV with a higher gain, e.g., as described below.

In some demonstrative aspects, the multi-element transmission mode may be configured, for example, to provide a technical solution to support a narrow FoV, a high directivity, and/or a high gain, for example, compared to the single-element transmission mode, e.g., as described below.

In some demonstrative aspects, the multi-mode transmission mechanism may be configured, for example, to provide a technical solution to support a multi-element transmission mode, e.g., an improved multi-element transmission mode, at which a plurality of multi-element transmissions may be transmitted via a plurality of multi-element antennas, and one or more single-element transmissions may be transmitted via one or more single-element antennas, e.g., as described below.

In some demonstrative aspects, the multi-mode transmission mechanism may be configured, for example, utilizing an antenna array including a Tx array including a first Tx sub-array including a plurality of first antenna elements, and a second Tx sub-array including a plurality of second antenna elements, e.g., as described below.

In some demonstrative aspects, the first Tx sub-array and the second Tx sub-array may be arranged in a staggered arrangement, e.g., as described below.

In some demonstrative aspects, the plurality of second antenna elements may be staggered with respect to the plurality of first antenna elements, e.g., as described below.

In other aspects, the multi-mode transmission mechanism may be configured with respect to any other suitable type, arrangement, and/or configuration of antenna array.

In some demonstrative aspects, a radar device, e.g., as described above with reference to FIGS. 1-9, may be configured to transmit a first plurality of single-element transmissions via the plurality of first antenna elements, respectively, and to transmit a second plurality of single-element transmissions via the plurality of second antenna elements, respectively, for example, at the single-element transmission mode, e.g., as described below.

In some demonstrative aspects, a radar device, e.g., as described above with reference to FIGS. 1-9, may be configured to transmit a first plurality of multi-element transmissions, and a second plurality of multi-element transmissions, for example, at the multi-element transmission mode, e.g., as described below.

In some demonstrative aspects, the first plurality of multi-element transmissions may be transmitted via a first plurality of multi-element antennas of the first sub-array of the antenna array, e.g., as described below.

In some demonstrative aspects, the second plurality of multi-element transmissions may be transmitted via a second plurality of multi-element antennas of the second sub-array of the antenna array, e.g., as described below.

In some demonstrative aspects, a multi-element antenna of the first sub-array may include two or more adjacent first antenna elements of the first Tx sub-array, e.g., as described below.

In some demonstrative aspects, a multi-element antenna of the second sub-array may include two or more adjacent second antenna elements of the second Tx sub-array, e.g., as described below.

In some demonstrative aspects, a radar device, e.g., as described above with reference to FIGS. 1-9, may be configured to control a first transmission according to the multi-element transmission mode, for example, to cover a first FoV, e.g., as described below.

In some demonstrative aspects, the radar device, e.g., as described above with reference to FIGS. 1-9, may be configured to control a second transmission according to the single-element transmission mode, for example, to cover a second FoV, different from the first FoV, e.g., as described below.

In some demonstrative aspects, the second FoV may be wider than the first FoV, e.g., as described below.

In some demonstrative aspects, a radar device, e.g., as described above with reference to FIGS. 1-9, may be configured to implement the multi-mode transmission mechanism, for example, to provide a technical solution to support a plurality of FoVs for the radar device, for example, while utilizing the same antenna elements of an antenna array, and a same element to element spacing between the antenna elements of the antenna array, e.g., as described below.

In some demonstrative aspects, a radar device, e.g., as described above with reference to FIGS. 1-9, may be configured to implement the multi-mode transmission mechanism, for example, to provide a technical solution to improve a link budget, for example, at the expense of a FoV of the antenna array, e.g., as described below.

In some demonstrative aspects, the multi-mode transmission mechanism may be configured to provide a technical solution to support a multi-mode system, for example, with a plurality of different transmission modes, e.g., to support a plurality of different FoVs and/or a plurality of different directivities and/or ranges, for example, with a same gain or a different gain, e.g., as described below.

In some demonstrative aspects, the multi-mode transmission mechanism may be configured to provide a technical solution to support a dual mode system, for example, with two different transmission modes, e.g., to support two different FoVs and/or two different directivities and/or ranges, for example, with a same gain or a different gain, e.g., as described below.

In some demonstrative aspects, the multi-mode transmission mechanism may be configured to provide a technical solution to support easy switching between the plurality of transmission modes, for example, based on driving conditions of a vehicle implementing the radar device, and/or any other conditions, settings, and/or the like.

In some demonstrative aspects, the multi-mode transmission mechanism may be configured to provide a technical solution to support utilization of the same HW for different types of units, for example, Long Range Radar (LRR) units and Middle Range Radar (MRR) units. Accordingly, this technical solution may be implemented, for example, to provide an advantage on the operation side.

In some demonstrative aspects, the multi-mode transmission mechanism may be configured to utilize a Tx waveform, which may be adapted, for example, per transmission mode, for example to support efficient utilization of Tx power.

In some demonstrative aspects, the multi-mode transmission mechanism may be implemented, for example, to provide a technical solution to support two or more transmission modes via one or more types of vertical or horizontal linear arrays.

In some demonstrative aspects, the multi-mode transmission mechanism may be implemented, for example, to provide a technical solution to support the two or more transmission modes via a dual-column array, for example, using both left and right columns, and/or a single-column array, for example, using only the left column or the right column, e.g., as described below.

In some demonstrative aspects, the multi-mode transmission mechanism may be implemented, for example, to provide a technical solution to support different modulation schemes, e.g., to support Doppler Division Multiple Access (DDMA), Tx coding, and/or the like, which may be combined with two or more transmission modes.

In some demonstrative aspects, the multi-mode transmission mechanism may be implemented, for example, as part of a radar device.

In some demonstrative aspects, the multi-mode transmission mechanism may be implemented as part of any other suitable device and/or system.

For example, in some demonstrative aspects, the multi-mode transmission mechanism may be implemented as part of a device, for example, a mobile device, a computing device, and/or a wireless communication device, for example, to communicate RF wireless communication signals.

For example, in some demonstrative aspects, the multi-mode transmission mechanism may be implemented to communicate RF wireless communication signals over millimeter wave (mmWave) frequencies and/or any other suitable frequencies.

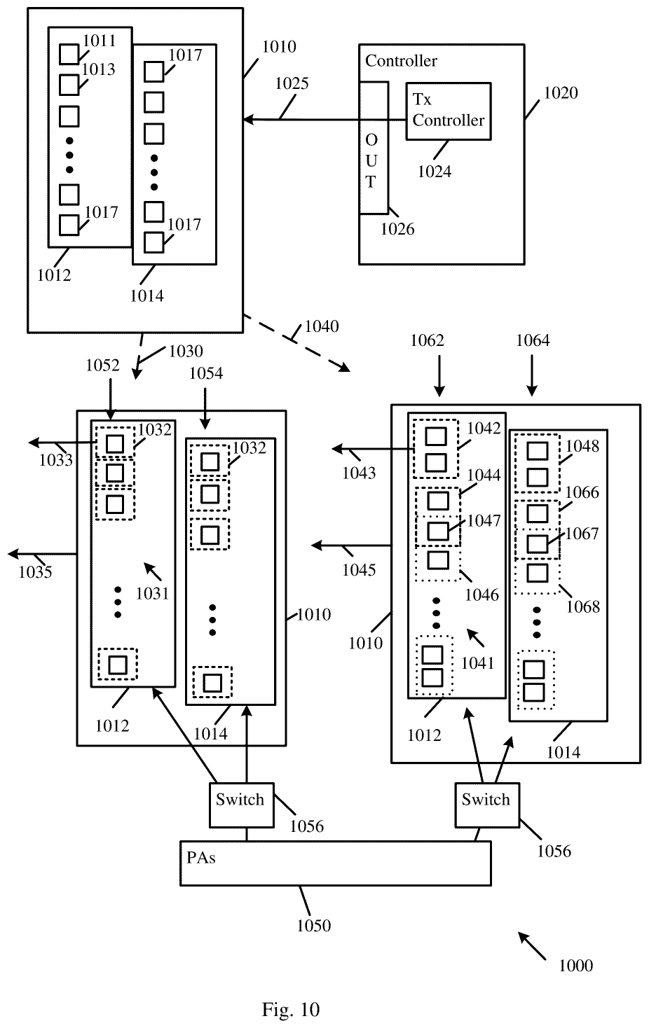

Reference is made to FIG. 10, which schematically illustrates a system 1000, in accordance with some demonstrative aspects.

In some demonstrative aspects, one or more elements of the system 1000 may be implemented by a radar device, e.g., radar device 800 (FIG. 8) and/or radar device 910 (FIG. 9), and/or a radar system, e.g., radar system 901 (FIG. 9).

In some demonstrative aspects, system 1000 may include an antenna array 1010, e.g., as described below. For example, MIMO antenna array 881 (FIG. 8) may include one or more elements of antenna array 1010, and/or may perform one or more operations and/or functionalities of antenna array 1010.

In some demonstrative aspects, the one or more Tx arrays 824 (FIG. 8) may include antenna array 1010, e.g., as described below.

In some demonstrative aspects, as shown in FIG. 10, system 1000 may include a controller 1020, e.g., as described below.

In some demonstrative aspects, controller 1020 may be implemented, for example, as part of a radar device, e.g., radar device 800 (FIG. 8) and/or radar device 910 (FIG. 9).

In some demonstrative aspects, controller 1020 may be implemented, for example, as part of a radar processor, e.g., radar processor 834 (FIG. 8), and/or BB processor 930 (FIG. 9).

For example, radar processor 834 (FIG. 8) may include one or more elements of controller 1020, and/or may perform one or more operations and/or functionalities of controller 1020.

In some demonstrative aspects, controller 1020 and antenna array 1010 may be implemented, for example, as part of a radar device, e.g., as described above.

In some demonstrative aspects, controller 1020 and antenna array 1010 may be implemented as part of any other suitable device and/or system.

For example, in some demonstrative aspects, controller 1020 and antenna array 1010 may be implemented as part of a device, for example, a mobile device, a computing device, and/or a wireless communication device, for example, to communicate RF wireless communication signals.

For example, in some demonstrative aspects, controller 1020 and antenna array 1010 may be implemented to communicate RF wireless communication signals over millimeter wave (mmWave) frequencies and/or any other suitable frequencies.

In some demonstrative aspects, controller 1020 may be configured to generate control signals 1025 to control transmissions via the antenna array 1010, e.g., as described below.

In some demonstrative aspects, controller 1020 may include a transmission controller 1024. For example, radar processor 834 (FIG. 8) may include one or more elements of transmission controller 1024, and/or may perform one or more operations and/or functionalities of transmission controller 1024; and/or BB processor 930 (FIG. 9) may include one or more elements of transmission controller 1024, and/or may perform one or more operations and/or functionalities of transmission controller 1024.

In some demonstrative aspects, transmission controller 1024 may include, or may be implemented, partially or entirely, by circuitry and/or logic, e.g., one or more processors including circuitry and/or logic, memory circuitry and/or logic. Additionally or alternatively, one or more functionalities of transmission controller 1024 may be implemented by logic, which may be executed by a machine and/or one or more processors, e.g., as described below.

In other aspects, transmission controller 1024 may be implemented as part of any other, dedicated, or non-dedicated, element of a radar device, e.g., radar device 800 (FIG. 8) or radar device 910 (FIG. 9), and/or a radar system, e.g., radar system 901 (FIG. 9).

In some demonstrative aspects, transmission controller 1024 may be configured to generate the control signals 1025, for example, to control the transmissions via the antenna array 1010, e.g., as described below.

In some demonstrative aspects, controller 1020 may include an output 1026, for example, to provide the control signals 1025, e.g., as described below.

In some demonstrative aspects, output 1026 may include any suitable output interface, output unit, output module, output component, output circuitry, memory interface, memory access unit, memory writer, digital memory unit, bus interface, processor interface, or the like, which may be capable of outputting the control signals 1025.

In some demonstrative aspects, transmission controller 1024 may be configured to generate the control signals 1025, for example, to control the transmissions via the antenna array 1010, for example, according to a plurality of transmission modes, e.g., as described below.

In some demonstrative aspects, the plurality of transmission modes may include a single-element transmission mode 1030, and a multi-element transmission mode 1040, e.g., as described below.

In some demonstrative aspects, the single-element transmission mode 1030 may include a plurality of single-element transmissions 1035 via a plurality of single-element antennas 1031, e.g., as described below.

In some demonstrative aspects, a single-element antenna 1032 may include a single antenna element 1011 of the antenna array 1010, e.g., as described below.

In some demonstrative aspects, a single-element transmission 1033 via the single-element antenna 1032 may include a transmission via the single antenna element 1011 of the antenna array 1010, e.g., as described below.

In some demonstrative aspects, the multi-element transmission mode 1040 may include a plurality of multi-element transmissions 1045 via a plurality of multi-element antennas 1041, e.g., as described below.

In some demonstrative aspects, a multi-element antenna 1042, e.g., each multi-element antenna, of the plurality of multi-element antennas 1041, may include two or more adjacent antenna elements of the antenna array 1010, e.g., as described below.

In one example, the multi-element antenna 1042 may include the antenna element 1011 and an antenna element 1013 of the antenna array 1010.

In some demonstrative aspects, a multi-element transmission 1043 via the multi-element antenna 1042 may include a simultaneous transmission via the two or more adjacent antenna elements of the antenna array 1010, e.g., as described below.

In one example, the multi-element transmission 1043 via the multi-element antenna 1042 may include a simultaneous transmission via the antenna element 1011 and the antenna element 1013 of the antenna array 1010.

In some demonstrative aspects, the plurality of multi-element transmissions 1045 via the plurality of multi-element antennas 1041 may include a plurality of dual-element transmissions 1045 via a plurality of dual-element antennas 1041, e.g., as described below.

In some demonstrative aspects, a dual-element antenna may include two adjacent antenna elements of the antenna array 1010, e.g., as described below.

In one example, the multi-element antenna 1042 may include a dual-element antenna including the antenna element 1011 and the antenna element 1013 of the antenna array 1010.

In other aspects, the multi-element antenna 1042 may include more than two antenna elements of the antenna array 1010. For example, the plurality of multi-element transmissions 1045 via the plurality of multi-element antennas 1041 may include a plurality of three-or-more-element transmissions 1045 via a plurality of three-or-more-element antennas 1041.

In some demonstrative aspects, transmission controller 1024 may be configured to identify a selected transmission mode from the plurality of transmission modes, e.g., as described below.

In some demonstrative aspects, transmission controller 1024 may be configured to generate the control signals 1025 to control the transmissions via the antenna array 1010, for example, according to the selected transmission mode, e.g., as described below.

In some demonstrative aspects, the transmission controller 1024 may be configured to generate the control signals 1025 to control the plurality of single-element transmissions 1035, for example, according to the single-element transmission mode 1030, for example, to cover a first FoV of the antenna array 1010, e.g., as described below.

In some demonstrative aspects, the transmission controller 1024 may be configured to generate the control signals 1025 to control the plurality of multi-element transmissions 1045, for example, according to the multi-element transmission mode 1040, for example, to cover a second FoV of the antenna array 1010, e.g., as described below.

In some demonstrative aspects, the second FoV may be different from the first FoV, e.g., as described below.

In some demonstrative aspects, the second FoV may be narrower than the first FoV, e.g., as described below.

In some demonstrative aspects, the second FoV may be less than 80% of the first FoV, e.g., as described below.

In some demonstrative aspects, the second FoV may be less than 70% of the first FoV, e.g., as described below.

In some demonstrative aspects, the second FoV may be less than 60% of the first FoV, e.g., as described below.

In some demonstrative aspects, the second FoV may be about 50% of the first FoV, e.g., as described below.

In some demonstrative aspects, the second FoV may be less than 50% of the first FoV, e.g., as described below.

In other aspects, the transmission controller 1024 may be configured to control the plurality of single-element transmissions 1035 and/or the plurality of multi-element transmissions 1045, for example, to cover any other suitable FoVs of the antenna array 1010.

In some demonstrative aspects, the transmission controller 1024 may be configured to control the multi-element transmission 1043 via the multi-element antenna 1042, for example, to form a multi-element radiation pattern of the multi-element antenna 1042, e.g., as described below.

In some demonstrative aspects, the multi-element radiation pattern of the multi-element antenna 1042 may be based, for example, on a combination of element radiation patterns of the two or more adjacent antenna elements of the multi-element antenna 1042, e.g., as described below.

For example, the multi-element radiation pattern of the multi-element antenna 1042 may be based, for example, on a combination of element radiation patterns of the antenna element 1013 and the antenna element 1011 of the multi-element antenna 1042.

In some demonstrative aspects, the multi-element radiation pattern of the multi-element antenna 1042 may be different from a single-element radiation pattern of the single-element antenna 1032, e.g., as described below.

In some demonstrative aspects, the multi-element radiation pattern of the multi-element antenna 1042 may be narrower than the single-element radiation pattern of the single-element antenna 1032, e.g., as described below.

In some demonstrative aspects, the plurality of multi-element antennas 1041 may be configured, for example, to form a virtual uniform Tx antenna array having a uniform spacing between virtual antenna elements of the virtual uniform Tx antenna array, e.g., as described below.

In some demonstrative aspects, a duration of the multi-element transmission 1043 via the multi-element antenna 1042 may be based, for example, on a duration of the single-element transmission 1033 of the plurality of single-element transmissions 1035, e.g., as described below.

In some demonstrative aspects, the duration of the multi-element transmission 1043 via the multi-element antenna 1042 may be based, for example, on a count of the two or more adjacent antenna elements of the multi-element antenna 1042, e.g., as described below.

In some demonstrative aspects, the duration of the multi-element transmission 1043 via the multi-element antenna 1042 may be based, for example, on the duration of the single-element transmission 1033 of the plurality of single-element transmissions 1035, and on the count of the two or more adjacent antenna elements of the multi-element antenna 1042, e.g., as described below.

In some demonstrative aspects, the multi-element transmission mode 1040 may include a plurality of pulses repeated in a plurality of multi-element mode Pulse Repetition Intervals (PRIs), e.g., as described below.

In some demonstrative aspects, a pulse of the plurality of pulses of the multi-element transmission mode 1040 may include the plurality of multi-element transmissions 1045 via the plurality of multi-element antennas 1041, e.g., as described below.

In some demonstrative aspects, the single-element transmission mode 1030 may include a plurality of pulses repeated in a plurality of single-element mode PRIs, e.g., as described below.

In some demonstrative aspects, a pulse of the plurality of pulses of the single-element transmission mode 1030 may include the plurality of single-element transmissions 1035 via the plurality of single-element antennas 1031, e.g., as described below.

In some demonstrative aspects, transmission controller 1024 may be configured to generate the control signals 1025 to control a staggered transmission of the plurality of multi-element transmissions 1045 during a multi-element mode PRI, e.g., as described below.

In some demonstrative aspects, the multi-element mode PRI may include a sequence of multi-element mode time slots, e.g., as described below.

In some demonstrative aspects, the staggered transmission of the plurality of multi-element transmissions 1045 may be configured, for example, such that the plurality of multi-element transmissions 1045 may start at a plurality of staggered multi-element mode start times, respectively, e.g., as described below.

In some demonstrative aspects, the plurality of staggered multi-element mode start times may be in a respective plurality of multi-element mode time slots of the sequence of multi-element mode time slots, e.g., as described below.

In some demonstrative aspects, transmission controller 1024 may be configured to generate the control signals 1025 to control a staggered transmission of the plurality of single-element transmissions 1035 during a single-element mode PRI, e.g., as described below.

In some demonstrative aspects, the single-element mode PRI may include a sequence of single-element mode time slots, e.g., as described below.

In some demonstrative aspects, the staggered transmission of the plurality of single-element transmissions 1035 may be configured, for example, such that the plurality of single-element transmissions 1035 may start at a plurality of staggered single-element mode start times, respectively, e.g., as described below.

In some demonstrative aspects, the plurality of staggered single-element mode start times may be in a respective plurality of single-element mode time slots of the sequence of single-element mode time slots, e.g., as described below.

In some demonstrative aspects, a duration of each of the plurality of multi-element mode time slots may be substantially equal to a duration of each of the plurality of single-element mode time slots, e.g., as described below.

In some demonstrative aspects, the plurality of multi-element antennas 1041 may include a first multi-element antenna and a second multi-element antenna, e.g., as described below.

In some demonstrative aspects, the first multi-element antenna may include two or more first adjacent antenna elements of the antenna array 1010, e.g., as described below.

In some demonstrative aspects, the second multi-element antenna may include two or more second adjacent antenna elements of the antenna array 1010, e.g., as described below.

In some demonstrative aspects, at least one antenna element in the two or more first adjacent antenna elements may not be included in the two or more second adjacent antenna elements, e.g., as described below.

In some demonstrative aspects, each antenna element in the two or more first adjacent antenna elements may not be included in the two or more second adjacent antenna elements, e.g., as described below.

In some demonstrative aspects, at least one antenna element in the two or more second adjacent antenna elements may not be included in the two or more first adjacent antenna elements, e.g., as described below.

In some demonstrative aspects, each antenna element in the two or more second adjacent antenna elements may not be included in the two or more first adjacent antenna elements, e.g., as described below.

In one example, the plurality of multi-element antennas 1041 may include multi-element antenna 1042 and a multi-element antenna 1044. For example, each antenna element in the two or more adjacent antenna elements of multi-element antenna 1042 may not be included in the two or more adjacent antenna elements of multi-element antenna 1044; and/or each antenna element in the two or more adjacent antenna elements of multi-element antenna 1044 may not be included in the two or more adjacent antenna elements of multi-element antenna 1042.

In another example, the plurality of multi-element antennas 1041 may include the multi-element antenna 1044 and a multi-element antenna 1046. For example, at least one antenna element in the two or more adjacent antenna elements of multi-element antenna 1044 may not be included in the two or more adjacent antenna elements of multi-element antenna 1046; and/or at least one antenna element in the two or more adjacent antenna elements of multi-element antenna 1046 may not be included in the two or more adjacent antenna elements of multi-element antenna 1044. For example, multi-element antenna 1044 and multi-element antenna 1046 may have a shared antenna element 1047, which may be shared between multi-element antenna 1044 and multi-element antenna 1046, while other antenna elements of multi-element antenna 1044 and multi-element antenna 1046 may not be shared between multi-element antenna 1044 and multi-element antenna 1046.

In some demonstrative aspects, transmission controller 1024 may be configured to generate the control signals 1025 to control the multi-element transmission 1043 via the multi-element antenna 1042, for example, such that the simultaneous transmission via the two or more adjacent antenna elements of the multi-element antenna 1042 may form a combined signal from a virtual antenna element, e.g., as described below.

In some demonstrative aspects, the combined signal from the virtual antenna element may be based, for example, on a combination of two or more signals via the two or more adjacent antenna elements of multi-element antenna 1042, e.g., as described below.

In some demonstrative aspects, the virtual antenna element may be based, for example, on a combination of the two or more adjacent antenna elements of multi-element antenna 1042, for example, antenna element 1011 and antenna element 1013, e.g., as described below.

In some demonstrative aspects, an area of the virtual antenna element corresponding to the multi-element antenna may be based, for example, on a sum of areas of the two or more adjacent antenna elements of the multi-element antenna, e.g., as described below.

For example, the area of the virtual antenna element, which may be based on the two or more adjacent antenna elements of multi-element antenna 1042, may be based, for example, on a sum of areas of the two or more adjacent antenna elements, e.g., a sum of areas of antenna element 1011 and antenna element 1013.

In some demonstrative aspects, a center of the virtual antenna element corresponding to the multi-element antenna may be based, for example, on centers of the two or more adjacent antenna elements of the multi-element antenna, e.g., as described below.

For example, the center of the virtual antenna element, which may be based on the two or more adjacent antenna elements of multi-element antenna 1042, may be based, for example, on centers of the two or more adjacent antenna elements, e.g., the center of antenna element 1011, and the center of antenna element 1013.

In some demonstrative aspects, a radiation pattern of the virtual antenna element corresponding to the multi-element antenna may be based, for example, on element radiation patterns of the two or more adjacent antenna elements of the multi-element antenna, e.g., as described below.

For example, a radiation pattern of the virtual antenna element, which may be based on the two or more adjacent antenna elements of multi-element antenna 1042, may be based, for example, on the two or more adjacent antenna elements of the multi-element antenna 1042, for example, an element radiation pattern of antenna element 1011, and an element radiation pattern of antenna element 1013, e.g., as described below.

In some demonstrative aspects, transmission controller 1024 may be configured to generate the control signals 1025 to control the simultaneous transmission via the two or more adjacent antenna elements of a multi-element antenna to include, for example, a simultaneous transmission of two or more signals via the two or more adjacent antenna elements, respectively, e.g., as described below.

For example, transmission controller 1024 may be configured to generate the control signals 1025 to control a simultaneous transmission via antenna elements of multi-element antenna 1042, for example, by controlling a simultaneous transmission of a first signal via antenna element 1011 and a second signal via antenna element 1013, e.g., as described below.

In some demonstrative aspects, transmission controller 1024 may be configured to generate the control signals 1025 to control the transmission of the two or more signals via the two or more adjacent antenna elements, for example, to start at substantially a same start time and to end at substantially a same end time, e.g., as described below.

In some demonstrative aspects, the two or more signals transmitted via the two or more adjacent antenna elements may be, for example, substantially coherent, e.g., as described below.

In some demonstrative aspects, the two or more signals transmitted via the two or more adjacent antenna elements may include, for example, a same signal, e.g., as described below.

In some demonstrative aspects, transmission controller 1024 may be configured to generate the control signals 1025 to control the plurality of multi-element transmissions 1045, which may include, for example, a first plurality of multi-element transmissions and a second plurality of multi-element transmissions, e.g., as described below.

In some demonstrative aspects, transmission controller 1024 may be configured to generate the control signals 1025 to control the first plurality of multi-element transmissions to be, for example, via a first plurality of multi-element antennas 1062 of a first sub-array 1012 of the antenna array 1010, e.g., as described below.

In some demonstrative aspects, transmission controller 1024 may be configured to generate the control signals 1025 to control the second plurality of multi-element transmissions to be, for example, via a second plurality of multi-element antennas 1064 of a second sub-array 1014 of the antenna array 1010, e.g., as described below.

In some demonstrative aspects, the transmission controller 1024 may be configured to generate the control signals 1025 to control a plurality of Power Amplifiers (PAs) 1050 to amplify the first plurality of multi-element transmissions via the first plurality of multi-element antennas 1062 of the first sub-array 1012 of the antenna array 1010, e.g., as described below.

In some demonstrative aspects, the transmission controller 1024 may be configured to generate the control signals 1025, for example, to switch (1056) the plurality of PAs 1050 to amplify the second plurality of multi-element transmissions via the second plurality of multi-element antennas 1064 of the second sub-array 1014 of the antenna array 1010, e.g., as described below.

In some demonstrative aspects, transmission controller 1024 may be configured to generate the control signals 1025 to control the plurality of single-element transmissions 1035 to include, for example, a first plurality of single-element transmissions and a second plurality of single-element transmissions, e.g., as described below.

In some demonstrative aspects, transmission controller 1024 may be configured to generate the control signals 1025 to control the first plurality of single-element transmissions to be, for example, via a first plurality of single-element antennas 1052 of the first sub-array 1012, e.g., as described below.

In some demonstrative aspects, transmission controller 1024 may be configured to generate the control signals 1025 to control the second plurality of single-element transmissions to be, for example, via a second plurality of single-element antennas 1054 of the second sub-array 1014, e.g., as described below.

In some demonstrative aspects, the transmission controller 1024 may be configured to generate the control signals 1025, for example, to control the plurality of PAs 1050 to amplify the first plurality of single-element transmissions via the first plurality of single-element antennas 1052 of the first sub-array 1012 of the antenna array 1010, e.g., as described below.

In some demonstrative aspects, the transmission controller 1024 may be configured to generate the control signals 1025, for example, to switch the plurality of PAs 1050 to amplify the second plurality of single-element transmissions via the second plurality of single-element antennas 1054 of the second sub-array 1014 of the antenna array 1010, e.g., as described below.

In some demonstrative aspects, the first sub-array 1012 and the second sub-array 1014 may be arranged in a staggered arrangement, for example, such that antenna elements of the second sub-array 1014 are staggered with respect to antenna elements of the first sub-array 1012, e.g., as described below.

In some demonstrative aspects, a multi-element antenna of the first plurality of multi-element antennas 1062, e.g., multi-element antenna 1042, may include two or more adjacent antenna elements, e.g., antenna element 1011 and antenna element 1013, of the first sub-array 1012, e.g., as described below.

In some demonstrative aspects, a multi-element antenna of the second plurality of multi-element antennas 1064, e.g., a multi-element antenna 1048, may include two or more adjacent antenna elements of the second sub-array 1014, e.g., as described below.

In some demonstrative aspects, transmission controller 1024 may be configured to generate the control signals 1025 to control the first plurality of multi-element transmissions to include, for example, a first plurality of first-sub-array multi-element transmissions via a first plurality of first-sub-array multi-element antennas of the first sub-array 1012, e.g., as described below.

In some demonstrative aspects, transmission controller 1024 may be configured to generate the control signals 1025 to control the first plurality of multi-element transmissions to include, for example, a second plurality of first-sub-array multi-element transmissions via a second plurality of first-sub-array multi-element antennas of the first sub-array 1012, e.g., as described below.

In some demonstrative aspects, transmission controller 1024 may be configured to generate the control signals 1025 to control the second plurality of multi-element transmissions to include, for example, a first plurality of second-sub-array multi-element transmissions via a first plurality of second-sub-array multi-element antennas of the second sub-array 1014, e.g., as described below.

In some demonstrative aspects, transmission controller 1024 may be configured to generate the control signals 1025 to control the second plurality of multi-element transmissions to include, for example, a second plurality of second-sub-array multi-element transmissions via a second plurality of second-sub-array multi-element antennas of the second sub-array 1014, e.g., as described below.

In some demonstrative aspects, at least one multi-element antenna of the first plurality of first-sub-array multi-element antennas of the first sub-array 1012 may include, for example, at least one same antenna element of a respective multi-element antenna of the second plurality of first-sub-array multi-element antennas of the first sub-array 1012, e.g., as described below.

In one example, multi-element antenna 1044 of the first plurality of first-sub-array multi-element antennas of the first sub-array 1012 may include, for example, the same antenna element 1047 of a respective multi-element antenna 1046 of the second plurality of first-sub-array multi-element antennas of the first sub-array 1012.

In some demonstrative aspects, at least one multi-element antenna of the first plurality of second-sub-array multi-element antennas of the second sub-array 1014 may include, for example, at least one same antenna element of a respective multi-element antenna of the second plurality of second-sub-array multi-element antennas of the second sub-array 1014, e.g., as described below.

In one example, a multi-element antenna 1066 of the first plurality of second-sub-array multi-element antennas of the second sub-array 1014 may include a same antenna element 1067 of a respective multi-element antenna 1068 of the second plurality of second-sub-array multi-element antennas of the second sub-array 1014.

In some demonstrative aspects, each multi-element antenna of the first plurality of first-sub-array multi-element antennas of the first sub-array 1012 may include at least one same antenna element of a respective multi-element antenna of the second plurality of first-sub-array multi-element antennas of the first sub-array 1012, e.g., as described below.

In some demonstrative aspects, each multi-element antenna of the first plurality of second-sub-array multi-element antennas of the second sub-array 1014 may include at least one same antenna element of a respective multi-element antenna of the second plurality of second-sub-array multi-element antennas of the second sub-array 1014, e.g., as described below.

In some demonstrative aspects, transmission controller 1024 may be configured to generate the control signals 1025 to control the multi-element transmission mode 1040 to include, for example, one or more single-element transmissions via one or more single-element antennas for the multi-element transmission mode 1040, e.g., as described below.

In some demonstrative aspects, the one or more single-element antennas for the multi-element transmission mode 1040 may include one or more edge antenna elements at one or more ends of the antenna array 1010, e.g., as described below.

In one example, the one or more single-element antennas for the multi-element transmission mode 1040 may include antenna element 1011, e.g., at an end of the first sub-array 1012, and/or one or more other edge antenna elements 1017, e.g., at a second end of the first sub-array 1012 and/or at one or more ends of the second sub-array 1014.

In other aspects, the one or more single-element antennas for the multi-element transmission mode 1040 may include any other additional or alternative antenna elements.

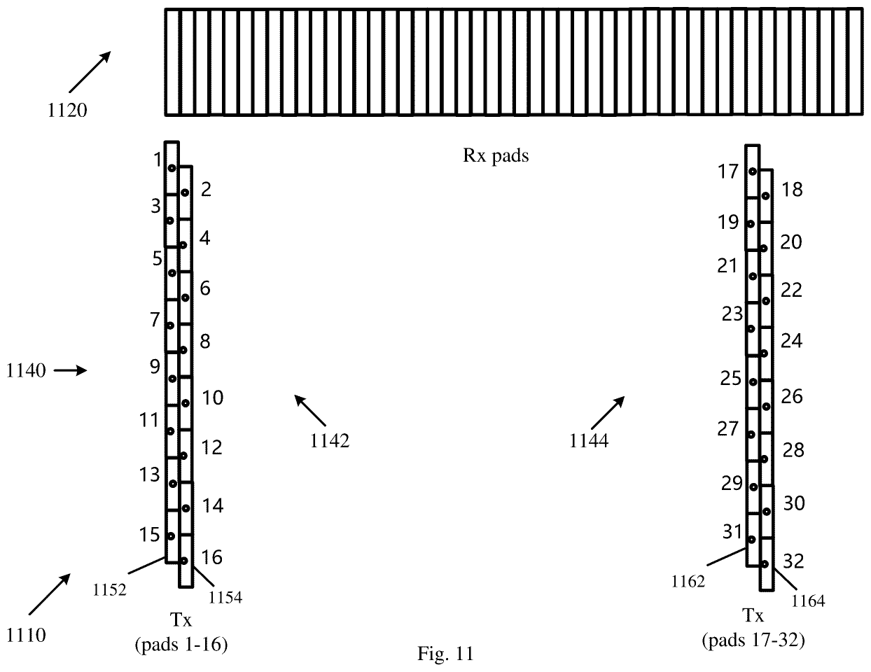

Reference is made to FIG. 11, which schematically illustrates an antenna array 1110, which may be implemented in accordance with some demonstrative aspects. For example, MIMO antenna array 881 (FIG. 8) may include one or more elements of antenna array 1110, and/or may perform one or more operations and/or functionalities of antenna array 1110.

In some demonstrative aspects, as shown in FIG. 11, antenna array 1110 may include a Tx array 1140 to transmit radar Tx signals.

In some demonstrative aspects, as shown in FIG. 11, antenna array 1110 may include an Rx array 1120 including a plurality of Rx antennas, which may be configured to receive radar Rx signals based on the radar Tx signals.

In some demonstrative aspects, as shown in FIG. 11, Tx array 1140 may include a first Tx array 1142 and a second Tx array 1144.

In some demonstrative aspects, antenna array 1010 (FIG. 10) may include one or more elements of first Tx array 1142 and/or second Tx array 1144, and/or may perform one or more operations and/or functionalities of first Tx array 1142 and/or second Tx array 1144.

In some demonstrative aspects, as shown in FIG. 11, first Tx array 1142 may include a first sub-array 1152, and a second sub-array 1154.

In some demonstrative aspects, as shown in FIG. 11, the first sub-array 1152 and the second sub-array 1154 may be arranged in a staggered arrangement, for example, such that antenna elements of the second sub-array 1154 are staggered with respect to antenna elements of the first sub-array 1152.

In some demonstrative aspects, as shown in FIG. 11, second Tx array 1144 may include a first sub-array 1162, and a second sub-array 1164.

In some demonstrative aspects, as shown in FIG. 11, the first sub-array 1162 and the second sub-array 1164 may be arranged in a staggered arrangement, for example, such that antenna elements of the second sub-array 1164 may be staggered with respect to antenna elements of the first sub-array 1162.

In some demonstrative aspects, as shown in FIG. 11, antenna array 1110 may include the Rx array 1120, which may include a plurality of Rx antenna elements arranged along a predefined axis; and the first Tx array 1142 and the second Tx array 1144, which may be arranged substantially perpendicular to the predefined axis.

For example, as shown in FIG. 11, antenna array 1110 may include the Rx array 1120 implemented in the form of a row of Rx antenna elements, the first Tx array 1142 implemented in the form of a first Tx column, and the second Tx array 1144 implemented in the form of a second Tx column.

For example, as shown in FIG. 11, the first Tx array 1142 may include the first sub-array 1152 as a first sub-column, and the second sub-array 1154 as a second sub-column, which may be staggered with respect to the first sub-column.

For example, as shown in FIG. 11, the second Tx array 1144 may include the first sub-array 1162 as a first sub-column, and the second sub-array 1164 as a second sub-column, which may be staggered with respect to the first sub-column.

In other aspects, antenna array 1110 may be configured to include more than 2 Tx arrays. In one example, antenna array 1110 may be configured to include 3 Tx columns, e.g., including the first Tx array 1142, the second Tx array 1144, and a third Tx array (not shown). In one example, antenna array 1110 may be configured to include 4 Tx columns, e.g., including the first Tx array 1142, the second Tx array 1144, and two additional Tx arrays (not shown). In other aspects, antenna array 1110 may be configured to include any other suitable count of Tx columns.

In some demonstrative aspects, as shown in FIG. 11, Tx array 1140 may include 32 Tx antenna elements, e.g., having Tx antenna element indexes 1 . . . 32.

For example, the first Tx array 1142 may include 16 Tx antenna elements, e.g., the Tx antenna elements 1 . . . 16. For example, the first sub-array 1152 may include 8 Tx antenna elements, e.g., the odd-indexed Tx antenna elements 1, 3, 5, 7, 9, 11, 13, 15. For example, the second sub-array 1154 may include 8 Tx antenna elements, e.g., the even-indexed Tx antenna elements 2, 4, 6, 8, 10, 12, 14, 16.

For example, the second Tx array 1144 may include 16 Tx antenna elements, e.g., the Tx antenna elements 17 . . . 32. For example, the first sub-array 1162 may include 8 Tx antenna elements, e.g., the odd-indexed Tx antenna elements 17, 19, 21, 23, 25, 27, 29, 31. For example, the second sub-array 1164 may include 8 Tx antenna elements, e.g., the even-indexed Tx antenna elements 18, 20, 22, 24, 26, 28, 30, 32.

In other aspects, Tx array 1140, first Tx array 1142, second Tx array 1144, first sub-array 1152, second sub-array 1154, first sub-array 1162, and/or second sub-array 1164 may be configured to include any other suitable count of Tx antenna elements.

It is noted that the antenna array 1110 is provided as one implementation of a Tx array to be implemented for a multi-mode transmission according to some demonstrative aspects. In other aspects, the multi-mode transmission mechanism may be implemented with respect to any other additional or alternative antenna array configuration and/or arrangement. For example, the antenna array may include a different count of antenna elements, a different assembly of antenna elements, different element positions, and/or different element alignment, for example, to support one or more implementation criteria, for example, different FoV modes.

In one example, the different FoV modes may be derived from customer requirements, from different supported scenarios, vehicle structures, and/or the like.

In some demonstrative aspects, a transmission controller, e.g., transmission controller 1024 (FIG. 10), may be configured to generate control signals, e.g., control signals 1025 (FIG. 10), to control a plurality of single-element transmissions via a plurality of single-element antennas of Tx array 1140, e.g., as described below.

In some demonstrative aspects, a single-element antenna may include a single antenna element of the Tx array 1140, e.g., as described below.

For example, the plurality of single-element transmissions may include a first plurality of single-element transmissions via a plurality of single antenna elements of Tx array 1142.

For example, the first plurality of single-element transmissions via the plurality of single antenna elements of Tx array 1142 may include a plurality of single-element transmissions via single antenna elements of Tx sub-array 1152, and/or a plurality of single-element transmissions via single antenna elements of Tx sub-array 1154.

For example, the plurality of single-element transmissions may include a second plurality of single-element transmissions via a plurality of single antenna elements of Tx array 1144.

For example, the second plurality of single-element transmissions via the plurality of single antenna elements of Tx array 1144 may include a plurality of single-element transmissions via single antenna elements of Tx sub-array 1162, and/or a plurality of single-element transmissions via single antenna elements of Tx sub-array 1164.

In some demonstrative aspects, a single-element antenna of Tx array 1140 may include a single element (pad) of Tx array 1140.

In some demonstrative aspects, a transmission controller, e.g., transmission controller 1024 (FIG. 10), may be configured to generate control signals, e.g., control signals 1025 (FIG. 10), to control a plurality of multi-element transmissions via a plurality of multi-element antennas of Tx array 1140.

In some demonstrative aspects, a multi-element antenna of Tx array 1140 may include two or more adjacent antenna elements of the Tx array 1140, e.g., as described below.

For example, the plurality of multi-element transmissions may include a first plurality of multi-element transmissions via a plurality of multi-element antennas of Tx array 1142.

For example, the first plurality of multi-element transmissions via the plurality of multi-element antennas of Tx array 1142 may include a plurality of multi-element transmissions via multi-element antennas of Tx sub-array 1152, and/or a plurality of multi-element transmissions via multi-element antennas of Tx sub-array 1154.

For example, a multi-element antenna of Tx sub-array 1152 may include two or more adjacent antenna elements of Tx sub-array 1152.

For example, a multi-element antenna of Tx sub-array 1154 may include two or more adjacent antenna elements of Tx sub-array 1154.

For example, the plurality of multi-element transmissions may include a second plurality of multi-element transmissions via a plurality of multi-element antennas of Tx array 1144.

For example, the second plurality of multi-element transmissions via the plurality of multi-element antennas of Tx array 1144 may include a plurality of multi-element transmissions via multi-element antennas of Tx sub-array 1162, and/or a plurality of multi-element transmissions via multi-element antennas of Tx sub-array 1164.

For example, a multi-element antenna of Tx sub-array 1162 may include two or more adjacent antenna elements of Tx sub-array 1162.

For example, a multi-element antenna of Tx sub-array 1164 may include two or more adjacent antenna elements of Tx sub-array 1164.

In some demonstrative aspects, a multi-element transmission via a multi-element antenna may include a simultaneous transmission via the two or more adjacent antenna elements of the multi-element antenna.

In some demonstrative aspects, a multi-element antenna of Tx array 1140 may include a set of, e.g., an aggregation of, two or more elements (pads), e.g., two adjacent pads.

In other aspects, a multi-element of Tx antenna array 1140 may include a set of, e.g., an aggregation of, more than two elements (pads), e.g., three, four or more adjacent elements (pads).

In some demonstrative aspects, the antenna array 1110 may be configured to implement an antenna feeding design according to a switch Power Amplifier (PA) architecture, in which a set of PAs, e.g., PAs 1050 (FIG. 1), may be utilized to feed elements of a first set of antenna elements (also referred to as “Set-A” or “Zig”), for example, a set including antenna elements of Tx array 1152 and Tx array 1162 having odd indexes, e.g., including the “odd” antenna elements 1, 3, 5, . . . 31.

In some demonstrative aspects, the switch PA architecture may be utilized to switch the set of PAs, e.g., PAs 1050 (FIG. 1), to feed a second set of antenna elements (also referred to as “Set-B” or “Zag”), for example, a set including antenna elements of Tx array 1154 and Tx array 1164 having “even” indexes, e.g., including the “even” antenna elements 2, 4, 6, . . . 32.

In some demonstrative aspects, a multi-mode transmission mechanism, e.g., as described herein, may implement the antenna feeding design according to the switch PA architecture, for example, to provide a technical solution to support a reduced number of Tx channels e.g., as described below.

In some demonstrative aspects, timing and switching of signals from the set of PAs may be derived, for example, according to the configuration of the antenna array 1110, the count of elements per multi-element, and/or any other attribute.

In some demonstrative aspects, a radar device, e.g., as described above with reference to FIGS. 1-9, may be configured to implement the multi-mode transmission mechanism, for example, by utilizing a dual-column array, for example, by utilizing both the right Tx array and the left Tx array of antenna array 1110, e.g., by utilizing both Tx array 1142 and Tx array 1144.

In other aspects, a radar device, e.g., as described above with reference to FIGS. 1-9, may be configured to implement the multi-mode transmission mechanism, for example, by utilizing a single-column Tx array, for example, by utilizing only one Tx array of the right Tx array and the left Tx array of antenna array 1110, e.g., by utilizing only Tx array 1142 or Tx array 1144.

In some demonstrative aspects, a multi-mode transmission mechanism may be configured to implement a single-element transmission mode, for example, utilizing the antenna array 1110, e.g., as described below. In other aspects, any other antenna array may be implemented.

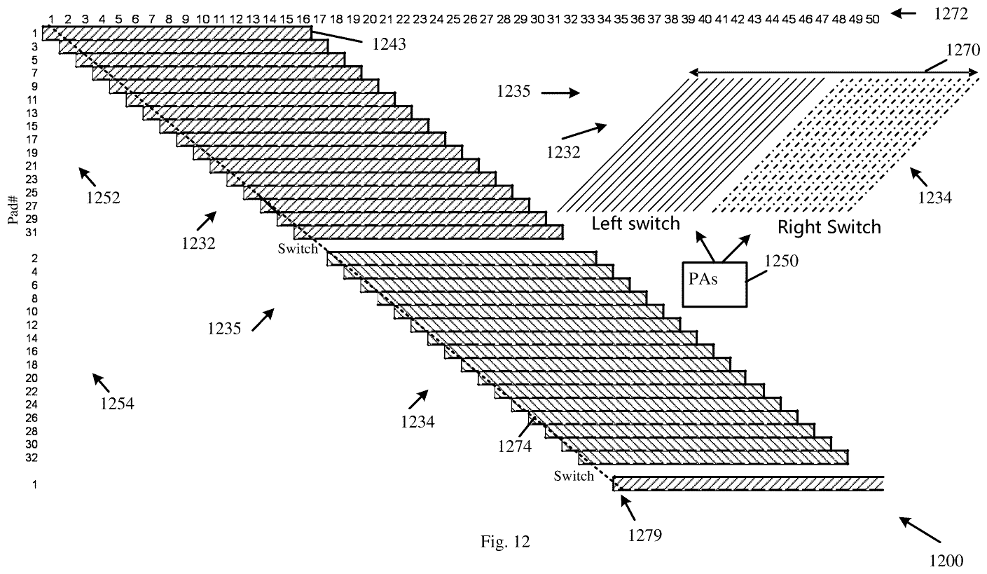

Reference is made to FIG. 12, which schematically illustrates a single-element transmission scheme 1200, in accordance with some demonstrative aspects.

In some demonstrative aspects, a transmission controller, e.g., transmission controller 1024 (FIG. 10), may be configured to generate control signals, e.g., control signals 1025 (FIG. 10), to control a plurality of single-element transmissions 1235 according to the single-element transmission scheme 1200.

In some demonstrative aspects, as shown in FIG. 12, the plurality of single-element transmissions 1235 may be via a plurality of single-element antennas of antenna array 1110 (FIG. 11).

In some demonstrative aspects, a single-element antenna of antenna array 1110 (FIG. 11) may include a single antenna element of the antenna array 1110 (FIG. 11).

In some demonstrative aspects, a single-element transmission via a single-element antenna of antenna array 1110 (FIG. 11) may include a transmission via a single antenna element of the antenna array 1110 (FIG. 11).

For example, as shown in FIG. 12, a single-element transmission 1243 via a single-element antenna of antenna array 1110 (FIG. 11) may include a transmission via the antenna element #1 of the antenna array 1110 (FIG. 11).

In some demonstrative aspects, as shown in FIG. 12, single-element transmission scheme 1200 may include transmitting via each antenna element of antenna array 1110 (FIG. 11) once, e.g., within a PRI 1270, e.g., as described below.

In some demonstrative aspects, the transmission controller, e.g., transmission controller 1024 (FIG. 10), may be configured to generate the control signals, e.g., control signals 1025 (FIG. 10), to control a staggered transmission of the plurality of single-element transmissions 1235 during a single-element mode PRI 1270.

In some demonstrative aspects, the single-element mode PRI 1270 may include a sequence of single-element mode time slots 1272.

For example, a duration of PRI 1270 may be based on the number of Tx antenna elements per Tx array (column). In one example, the duration of PRI 1270 may be determined based on (2+2*N)*Tslot, wherein N denotes a count of Tx antenna elements per Tx array (column), e.g., N=16, and Tslot denotes a duration of a transmission slot 1272.

In some demonstrative aspects, the staggered transmission of the plurality of single-element transmissions 1235 may be configured, for example, such that the plurality of single-element transmissions 1235 start at a plurality of staggered single-element mode start times 1274, respectively.

In some demonstrative aspects, the plurality of staggered single-element mode start times 1274 may be in a respective plurality of single-element mode time slots 1279 of the sequence of single-element mode time slots 1272.

In some demonstrative aspects, as shown in FIG. 12, the plurality of single-element transmissions 1235 may include a first plurality of single-element transmissions 1232, and a second plurality of single-element transmissions 1234.

In some demonstrative aspects, as shown in FIG. 12, the first plurality of single-element transmissions 1234 may be via a first plurality of single-element antennas 1252 of sub-array 1152 (FIG. 11) and sub-array 1162 (FIG. 11).

In some demonstrative aspects, as shown in FIG. 12, the second plurality of single-element transmissions 1234 may be via a second plurality of single-element antennas 1254 of sub-array 1154 (FIG. 11) and sub-array 1164 (FIG. 11).

In some demonstrative aspects, as shown in FIG. 12, single-element transmission scheme 1200 may include a transmission via substantially all antenna elements 1252 of the Set-A of antenna array 1110 (FIG. 11), e.g., the transmissions 1232 via antenna elements 1, 3, 5 . . . 31, which may be followed by a transmission via substantially all antenna elements 1254 of the Set-B of antenna array 1110 (FIG. 11), e.g., the transmissions 1234 via antenna elements 2, 4, 6, . . . 32.

In some demonstrative aspects, the transmission controller, e.g., transmission controller 1024 (FIG. 10), may be configured to generate the control signals, e.g., control signals 1025 (FIG. 10), to control a plurality of PAs 1250, e.g., PAs 1050 (FIG. 10), to amplify the first plurality of single-element transmissions 1232 via the first plurality of single-element antennas 1252 of sub-array 1152 (FIG. 11) and sub-array 1162 (FIG. 11).

In some demonstrative aspects, the transmission controller, e.g., transmission controller 1024 (FIG. 10), may be configured to generate the control signals, e.g., control signals 1025 (FIG. 10), to switch the plurality of PAs 1250, e.g., PAs 1050 (FIG. 10), to amplify the second plurality of single-element transmissions 1234 via the second plurality of single-element antennas 1254 of sub-array 1154 (FIG. 11) and sub-array 1164 (FIG. 11).

In some demonstrative aspects, a FoV of the antenna array 1110 (FIG. 11) according to the single-element transmission scheme 1200 may be wide, and may be based, for example, on a pattern of a single element of antenna array 1110 (FIG. 11).

In some demonstrative aspects, the transmission controller, e.g., transmission controller 1024 (FIG. 10), may be configured to generate the control signals, e.g., control signals 1025 (FIG. 10), to control the plurality of single-element transmissions 1235, for example, to cover a wide FoV of antenna array 1110 (FIG. 11).

In some demonstrative aspects, a multi-mode transmission mechanism may be configured to implement a multi-element transmission mode, for example, utilizing the antenna array 1110 (FIG. 11), e.g., as described below. In other aspects, any other antenna array may be implemented.

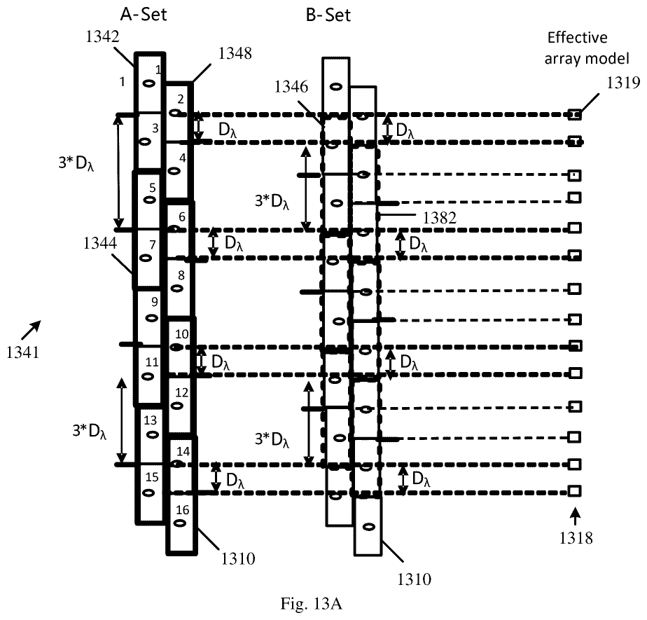

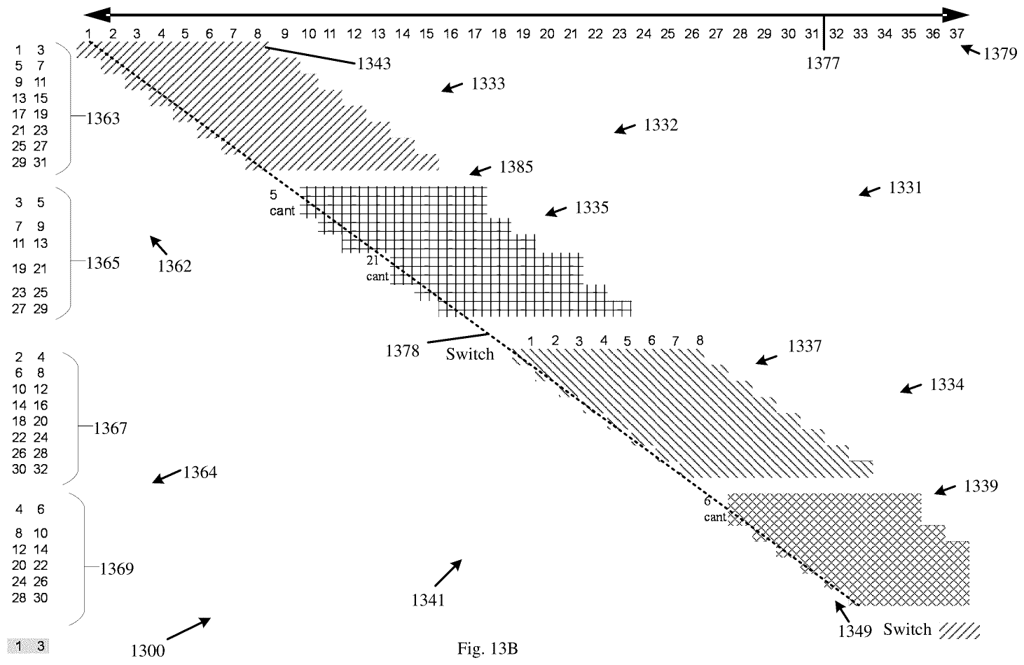

Reference is made to FIG. 13A, which schematically illustrates a plurality of multi-element antennas 1341 based on antenna elements of an antenna array 1310, and to FIG. 13B, which schematically illustrates a multi-element transmission scheme 1300 configured based on the plurality of multi-element antennas 1341 of FIG. 13A, in accordance with some demonstrative aspects.

For example, antenna array 1010 (FIG. 10) may include one or more elements of antenna array 1310, and/or may perform one or more operations and/or functionalities of antenna array 1310.

In some demonstrative aspects, antenna array 1310 may include one or more elements of first Tx array 1142 (FIG. 11) and/or second Tx array 1144 (FIG. 11), and/or may perform one or more operations and/or functionalities of first Tx array 1142 (FIG. 11) and/or second Tx array 1144 (FIG. 11).

In some demonstrative aspects, a transmission controller, e.g., transmission controller 1024 (FIG. 10), may be configured to generate control signals, e.g., control signals 1025 (FIG. 10), to control a plurality of multi-element transmissions 1331 via the plurality of multi-element antennas 1341 of antenna array 1310, for example, according to the multi-element transmission scheme 1300.

In some demonstrative aspects, as shown in FIG. 13A, a multi-element antenna 1341, e.g., each multi-element antenna 1341, of the plurality of multi-element antennas 1341, may include two or more adjacent antenna elements of the antenna array 1310.

In some demonstrative aspects, as shown in FIG. 13A, a multi-element antenna 1341, e.g., each multi-element antenna 1341, of the plurality of multi-element antennas 1341, may include a dual-element antenna 1341, for example, including two adjacent antenna elements of the antenna array 1310.

In some demonstrative aspects, as shown in FIG. 13A, the plurality of multi-element antennas 1341 may include a multi-element antenna 1342.

In some demonstrative aspects, as shown in FIG. 13A, the multi-element antenna 1342 may include may include two adjacent antenna elements of the antenna array 1310, e.g., including an antenna element #1 and an antenna element #3 of the antenna array 1310.

In some demonstrative aspects, as shown in FIG. 13A, the plurality of multi-element antennas 1341 may include a multi-element antenna 1344.

In some demonstrative aspects, as shown in FIG. 13A, the multi-element antenna 1344 may include two adjacent antenna elements of the antenna array 1310, e.g., including an antenna element #5 and an antenna element #7 of the antenna array 1310.

In some demonstrative aspects, at least one antenna element in multi-element antenna 1342 may not be included in multi-element antenna 1344.

In some demonstrative aspects, at least one antenna element antenna element in multi-element antenna 1344 may not be included in multi-element antenna 1342.

In some demonstrative aspects, each antenna element in multi-element antenna 1342 may not be included in multi-element antenna 1344.

In some demonstrative aspects, each antenna element in multi-element antenna 1344 may not be included in multi-element antenna 1342.

In some demonstrative aspects, the plurality of multi-element antennas 1341 may include a multi-element antenna 1346.

In some demonstrative aspects, as shown in FIG. 13A, the multi-element antenna 1346 may include two adjacent antenna elements of the antenna array 1310, e.g., including the antenna element #3 and the antenna element #5.

In some demonstrative aspects, as shown in FIG. 13A, multi-element antenna 1342 and multi-element antenna 1346 may have a shared antenna element, e.g., the antenna element #3, which may be shared between multi-element antenna 1342 and multi-element antenna 1346.

In some demonstrative aspects, as shown in FIG. 13A, multi-element antenna 1344 and multi-element antenna 1346 may have a shared antenna element, e.g., the antenna element #5, which may be shared between multi-element antenna 1344 and multi-element antenna 1346.

In some demonstrative aspects, as shown in FIG. 13B, a multi-element transmission 1331, e.g., each multi-element transmission 1331, via a multi-element antenna 1341 may include a simultaneous transmission via two or more adjacent antenna elements of the antenna array 1310.

In some demonstrative aspects, as shown in FIG. 13B, a multi-element transmission 1343 via the multi-element antenna 1342 may include a simultaneous transmission via the antenna element #1 and the antenna element #3 of the antenna array 1310.

In some demonstrative aspects, the simultaneous transmission via the antenna element #1 and the antenna element #3 may include a simultaneous transmission of two signals via the two adjacent antenna elements, respectively.

In some demonstrative aspects, the transmission controller, e.g., transmission controller 1024 (FIG. 10), may be configured to generate the control signals, e.g., control signals 1025 (FIG. 10), to control the transmission of the two signals, e.g., via the antenna element #1 and the antenna element #3, to start at substantially a same start time and to end at substantially a same end time.

In some demonstrative aspects, the two signals via the antenna element #1 and the antenna element #3 may be substantially coherent.

In some demonstrative aspects, the two signals via the antenna element #1 and the antenna element #3 may include a same signal.

In some demonstrative aspects, as shown in FIG. 13A, the plurality of multi-element antennas 1341 may be configured to form a virtual uniform Tx antenna array 1318 having, for example, a uniform spacing between virtual antenna elements of the virtual uniform Tx antenna array 1318.

In one example, the multi-element transmission scheme 1300 may be configured according to a pad coupling, e.g., to define which pads are coupled together for a multi-element virtual element, which may be selected, for example, such that an effective array of the transmission, e.g., virtual array 1318, may generate a uniform distribution along an elevation dimension. For example, the selection of the pad coupling to generate the uniform distribution along the elevation dimension may provide a technical solution to improve a vertical resolution, and/or to simplify a signal processing complexity.

In some demonstrative aspects, the multi-element transmission scheme 1300 may be configured according to a pad coupling, which may be selected, for example, such that the pads coupled together for a multi-element virtual element may not interfere, may generate uniform separation, and/or may provide a maximum link budget.

In some demonstrative aspects, the transmission controller, e.g., transmission controller 1024 (FIG. 10), may be configured to generate the control signals, e.g., control signals 1025 (FIG. 10), to control the multi-element transmission 1343 via the multi-element antenna 1342, for example, such that the simultaneous transmission via the antenna element #1 and the antenna element #3 may form a combined signal from a virtual antenna element 1319.

In some demonstrative aspects, the combined signal may be based, for example, on a combination of the signal via the antenna element #1 and the signal via the antenna element #3 of multi-element antenna 1342.

In some demonstrative aspects, the virtual antenna element 1319 may be based, for example, on a combination of the antenna element #1 and the antenna element #3.

In some demonstrative aspects, an area of the virtual antenna element 1319 may be based, for example, on a sum of areas of the antenna element #1 and the antenna element #3.

In some demonstrative aspects, a center of the virtual antenna element 1319 may be based, for example, on the center of the antenna element #1 and the center of the antenna element #3. For example, the center of the virtual antenna element 1319 may be substantially at a center point between the center of the antenna element #1 and the center of the antenna element #3.

In one example, an effective pad area of the multi-element virtual element 1319, e.g., as will be viewed by a receiver (Rx), may be a center, or an average between centers, of the two or more transmitting pads of the multi-element antenna 1342 corresponding to the virtual element 1319.

In one example, as shown in FIG. 13A, two-adjacent sub-arrays of the antenna array 1310 may be staggered according to a staggering distance, denoted D_{λ}, wherein λ denotes a wavelength of RF signals to be communicated via the antenna 1310. For example, as shown in FIG. 13A, the distance between the center of the antenna element #2 and the center of the antenna element #3 may be substantially equal to D_{λ}. For example, as shown in FIG. 13A, the distance between the center of the multi-element antenna 1342 and the center of the multi-element antenna 1344 may be substantially equal to 3*D_{λ}.

In some demonstrative aspects, a radiation pattern of the virtual antenna element 1319 may be based, for example, on element radiation patterns of the antenna element #1 and the antenna element #3 forming the multi-element antenna 1342.

In some demonstrative aspects, the multi-element transmission scheme 1300 may be configured to provide a technical solution to virtually combine two or more antenna elements of an antenna array, e.g., two or more adjacent pads of antenna array 1310, for example, into a multi-element virtual element 1319, for example, by transmitting a same signal via the two or more antenna elements, e.g., substantially simultaneously and/or substantially coherently.

In some demonstrative aspects, the multi-element transmission scheme 1300 may be configured to provide a technical solution to virtually combine two antenna elements of antenna array 1110 (FIG. 11), e.g., two or more adjacent pads of antenna array 1110 (FIG. 11), into a dual-element virtual element, for example, by simultaneously and coherently transmitting a same signal via two antenna elements of antenna array 1310.

In other aspects, the multi-element transmission scheme 1300 may be configured to combine three or more antenna elements of antenna array 1110 (FIG. 11), e.g., three or more adjacent pads of antenna array 1110 (FIG. 11), into a 3-or-more-element virtual element, for example, by simultaneously and coherently transmitting a same signal via the three or more antenna elements of antenna array 1110 (FIG. 11).

In some demonstrative aspects, the transmission controller, e.g., transmission controller 1024 (FIG. 10), may be configured to generate the control signals, e.g., control signals 1025 (FIG. 10), to control the multi-element transmission 1343 via the multi-element antenna 1342, for example, to form the radiation pattern of the virtual antenna element 1319 of the multi-element antenna 1342.

In some demonstrative aspects, the multi-element radiation pattern of the multi-element antenna 1342 may be different from a single-element radiation pattern of a single-element antenna, e.g., single-element antenna 1032 (FIG. 10).

In some demonstrative aspects, the multi-element radiation pattern of the multi-element antenna 1342 may be narrower than the single-element radiation pattern of the single-element antenna 1032 (FIG. 10).

In some demonstrative aspects, a duration of the multi-element transmission 1343 via the multi-element antenna 1342 may be based, for example, on a duration of the single-element transmission 1243 (FIG. 12), and on a count of the two or more adjacent antenna elements of the multi-element antenna 1342.

In one example, the duration of the multi-element transmission 1343 may be based on a ratio between the duration of the single-element transmission 1243 (FIG. 12), and the count of the two or more adjacent antenna elements of the multi-element antenna 1342.

For example, the duration of the multi-element transmission 1343 may include 8 time slots, for example, in case single-element transmission 1243 (FIG. 12) has a duration 16 time slots, and the multi-element antenna 1342 includes two adjacent antenna elements.

In some demonstrative aspects, the transmission controller, e.g., transmission controller 1024 (FIG. 10), may be configured to generate the control signals, e.g., control signals 1025 (FIG. 10), to control the plurality of multi element transmissions 1331 to cover a multi-element FoV of the antenna array 1310. For example, the multi-element FoV may be different from a single-element FoV of the antenna array 1310, for example, according to the single-element transmission scheme 1200 (FIG. 12).

In some demonstrative aspects, the multi-element FoV may be narrower than the single-element FoV.

In some demonstrative aspects, a multi-element transmission mode, e.g., multi-element transmission mode 1040 (FIG. 10), may include a plurality of pulses repeated in a plurality of multi-element mode PRIs 1377.

In some demonstrative aspects, a pulse may include the plurality of multi-element transmissions 1331 via the plurality of multi-element antennas 1341.

In some demonstrative aspects, the transmission controller, e.g., transmission controller 1024 (FIG. 10), may be configured to generate the control signals, e.g., control signals 1025 (FIG. 10), to control a staggered transmission of the plurality of multi-element transmissions 1331 during a multi-element mode PRI 1377.

In some demonstrative aspects, as shown in FIG. 13B, the multi-element mode PRI 1377 may include a sequence of multi-element mode time slots 1379.

In some demonstrative aspects, as shown in FIG. 13B, the staggered transmission of the plurality of multi-element transmissions 1331 may be configured, for example, such that the plurality of multi-element transmissions 1331 start at a plurality of staggered multi-element mode start times 1378, respectively.

In some demonstrative aspects, as shown in FIG. 13B, the plurality of staggered multi-element mode start times 1378 may be in a respective plurality of multi-element mode time slots 1349 of the sequence of multi-element mode time slots 1379.

In some demonstrative aspects, a duration of each of the plurality of multi-element mode time slots 1379 may be substantially equal to a duration of each of the plurality of single-element mode time slots 1272 (FIG. 12).

In some demonstrative aspects, as shown in FIG. 13B, the plurality of multi-element transmissions 1331 may include a first plurality of multi-element transmissions 1332, and a second plurality of multi-element transmissions 1334.

In some demonstrative aspects, as shown in FIG. 13B, the first plurality of multi-element transmissions 1332 may be via a first plurality of multi-element antennas 1362 of sub-array 1152 (FIG. 11) and sub-array 1162 (FIG. 11).

In some demonstrative aspects, as shown in FIG. 13B, the second plurality of multi-element transmissions 1334 may be via a second plurality of multi-element antennas 1364 of sub-array 1154 (FIG. 11) and sub-array 1164 (FIG. 11).

In some demonstrative aspects, the transmission controller, e.g., transmission controller 1024 (FIG. 10), may be configured to generate the control signals, e.g., control signals 1025 (FIG. 10), to control a plurality of PAs, e.g., PAs 1050 (FIG. 10), to amplify the first plurality of multi-element transmissions 1332 via the first plurality of multi-element antennas 1362 of sub-array 1152 (FIG. 11) and sub-array 1162 (FIG. 11).

In some demonstrative aspects, the transmission controller, e.g., transmission controller 1024 (FIG. 10), may be configured to generate the control signals, e.g., control signals 1025 (FIG. 10), to switch the plurality of PAs to amplify the second plurality of multi-element transmissions 1334 via the second plurality of multi-element antennas 1364 of sub-array 1154 (FIG. 11) and sub-array 1164 (FIG. 11), e.g., after the plurality of multi-element transmissions 1332.

In some demonstrative aspects, the multi-element transmission scheme 1300 may implement a switch PA architecture, in which the plurality of PAs may be used to feed elements of a first set of multi-element sets (Set-A or Zig), e.g., including multi-element antennas 1362, and then to feed a second set of multi-element sets (Set-B or Zag), e.g., including multi-element antennas 1364, for example, to provide a technical solution to support a reduced number of Tx channels e.g., as described below.

In some demonstrative aspects, as shown in FIG. 13B, a multi-element antenna of the first plurality of multi-element antennas 1362, e.g., multi-element antenna 1342, may include two or more adjacent antenna elements of sub-array 1152 (FIG. 11) and sub-array 1162 (FIG. 11).

In some demonstrative aspects, as shown in FIG. 13B, a multi-element antenna of the second plurality of multi-element antennas 1364, e.g., a multi-element antenna 1348, may include two or more adjacent antenna elements of sub-array 1154 (FIG. 11) and sub-array 1164 (FIG. 11).

In some demonstrative aspects, as shown in FIG. 13B, the first plurality of multi-element transmissions 1332 may include a first plurality of first-sub-array multi-element transmissions 1333 via a first plurality of first-sub-array multi-element antennas 1363 of the sub-array 1152 (FIG. 11) and sub-array 1162 (FIG. 11), e.g., the pairs of adjacent antenna elements (1+3), (5+7), . . . , (29+31).

In some demonstrative aspects, as shown in FIG. 13B, the first plurality of multi-element transmissions 1332 may include a second plurality of first-sub-array multi-element transmissions 1335 via a second plurality of first-sub-array multi-element antennas 1365 of the sub-array 1152 (FIG. 11) and sub-array 1162 (FIG. 11), e.g., the pairs of adjacent antenna elements (3+5), (7+9), . . . , (27+29).

In some demonstrative aspects, as shown in FIG. 13B, the second plurality of multi-element transmissions 1334 may include a first plurality of second-sub-array multi-element transmissions 1337 via a first plurality of second-sub-array multi-element antennas 1367 of the sub-array 1154 (FIG. 11) and sub-array 1164 (FIG. 11), e.g., the pairs of adjacent antenna elements (2+4), (6+8), . . . , (30+32).

In some demonstrative aspects, as shown in FIG. 13B, the second plurality of multi-element transmissions 1334 may include a second plurality of second-sub-array multi-element transmissions 1339 via a second plurality of second-sub-array multi-element antennas 1369 of the sub-array 1154 and 1164 (FIG. 11), e.g., the antenna pairs of adjacent elements (4+6), (8+10), . . . , (28+30).

In some demonstrative aspects, at least one multi-element antenna of the first plurality of first-sub-array multi-element antennas 1363 may include at least one same antenna element of a respective multi-element antenna of the second plurality of first-sub-array multi-element antennas 1365.

In one example, multi-element antenna 1342 of the first plurality of first-sub-array multi-element antennas 1363, e.g., including the antenna element #1 and the antenna element #3, may include the same antenna element #3 of the respective multi-element antenna 1346, e.g., including the antenna element #3 and the antenna element #5, of the second plurality of first-sub-array multi-element antennas 1365.

In some demonstrative aspects, at least one multi-element antenna of the first plurality of second-sub-array multi-element antennas 1367 may include at least one same antenna element of a respective multi-element antenna of the second plurality of second-sub-array multi-element antennas 1369.

In one example, a multi-element antenna 1348, e.g., including the antenna element #2 and an antenna element #4, of the first plurality of second-sub-array multi-element antennas 1367 may include the same antenna element #4 of a respective multi-element antenna 1382, e.g., including the antenna element #4 and an antenna element #6 of the second plurality of second-sub-array multi-element antennas 1369.

In some demonstrative aspects, as shown in FIG. 13B, each multi-element antenna of the first plurality of first-sub-array multi-element antennas 1363 may include at least one same antenna element of a respective multi-element antenna of the second plurality of first-sub-array multi-element antennas 1365.

In some demonstrative aspects, as shown in FIG. 13B, each multi-element antenna of the first plurality of second-sub-array multi-element antennas 1367 may include at least one same antenna element of a respective multi-element antenna of the second plurality of second-sub-array multi-element antennas 1369.

In some demonstrative aspects, the multi-element transmission scheme 1300 may support an improved radar directivity of the antenna array 1310, for example, based on the same configuration of the antenna array 1110 (FIG. 11) utilized for the single-element transmission scheme 1200 (FIG. 12).

In some demonstrative aspects, the multi-element transmission scheme 1300 may be extended to support multi-element transmissions via 3 or more antenna elements. For example, the multi-element transmission scheme 1300 may be extended to support a plurality of multi-element transmissions via 3-element antennas of the Set-A, e.g., using the sets 1-3, 5-7, . . . , followed by a plurality of multi-element transmission via 3-element antennas of the Set-B, e.g., using the sets 2-4, 6-8, . . . , or any other setting.

In some demonstrative aspects, the multi-element transmission scheme 1300 may include a transmission of a same waveform, e.g., the exact same waveform, via two transmit chains, for example, at a transmission slot 1379. For example, this setting may be utilized to form a narrower emission with a stronger effective transmitted power, e.g., due to coherent combining. For example, the multi-element transmission scheme 1300 may include transmissions in 8 slots via the Set A, followed by a switch to transmit via the set-B, for example, instead of sending a chirp for 16 slots, e.g., at the single-element transmission scheme 1200 (FIG. 12).

In some demonstrative aspects, the multi-element transmission scheme 1300 may include a waiting period 1385, which may be used to ensure that both of the Tx chains from a previous set finish the transmission, for example, before a new set can be activated.

For example, in slot #9, it may be desired to start to transmit via the multi-element antenna “3+5”. However, it may not be possible to start this transmission in slot #9, e.g., as the Tx chain #5 may still be occupied with a previous transmission, e.g., the transmission via the multi-element antenna “5+7”, which may include transmission via the Tx chain #5 and the Tx chain #7.

In some demonstrative aspects, some of the edge (external) pads, e.g., Tx #1, Tx #31, may not be allocated under the requirement of generating a uniform virtual array according to the multi-element transmission scheme. As a result, the multi-element transmission scheme 1300 may support a limited utilization of the whole antenna array 1110 (FIG. 11).

In some demonstrative aspects, the multi-element transmission scheme 1300 may have a link budget improvement, e.g., compared to a baseline link budget of single-element transmission scheme 1200 (FIG. 12).

In some demonstrative aspects, this improvement in the link budget may be achieved even without changing the hardware, e.g., by using the same antenna elements of antenna array 1110 (FIG. 11), and/or even without changing the element spacing of antenna array 1110 (FIG. 11), for example, to provide a same ambiguity behavior.

In some demonstrative aspects, the multi-element transmission scheme 1300 may be implemented to provide a technical solution to support narrowing a Tx FoV of an antenna array, e.g., antenna array 1110 (FIG. 11), for example, by a factor of two, for example, compared to a FoV provided by the single-mode transmission scheme 1200 (FIG. 12).

In some demonstrative aspects, an overall FoV of antenna array 1110 (FIG. 11) according to the multi-element transmission scheme 1300 may be narrowed down by a factor of approximately 1.5, for example, since an Rx FoV may remain substantially the same in all transmission modes.

In some demonstrative aspects, a multi-mode transmission mechanism may be configured to implement a multi-element transmission mode, which may be configured to provide one or more improved results, for example, while utilizing the antenna array 1310.

In some demonstrative aspects, a multi-element transmission mode may be configured to include one or more single-element transmissions via one or more single-element antennas for the multi-element transmission mode, e.g., as described below.

In some demonstrative aspects, the one or more single-element antennas for the multi-element transmission mode may include one or more edge antenna elements at one or more ends of the antenna array 1310, e.g., as described below.

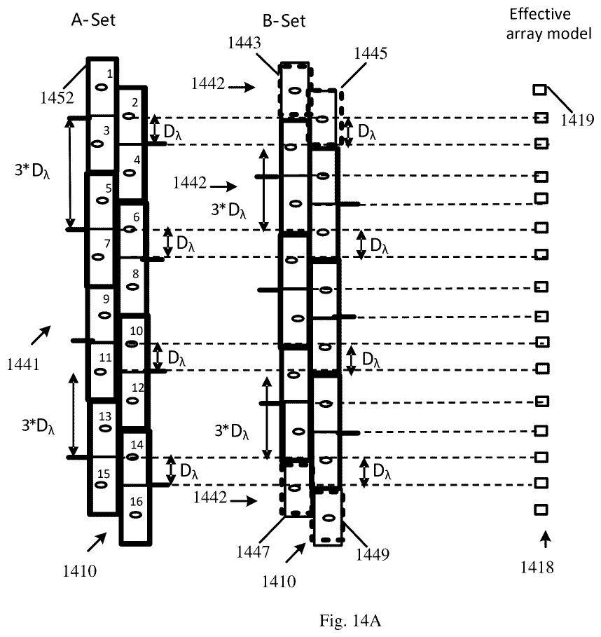

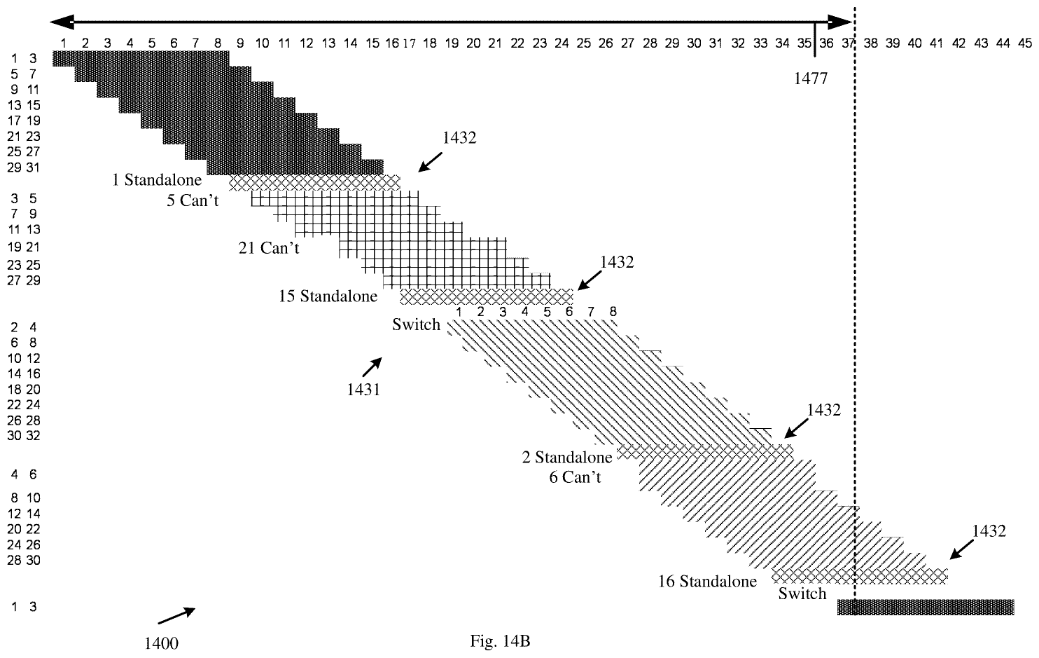

Reference is made to FIG. 14A, which schematically illustrates a plurality of multi-element antennas 1441 and single-element antennas 1442 based on antenna elements of an antenna array 1410, and to FIG. 14B, which schematically illustrates a multi-element transmission scheme 1400 configured based on the plurality of multi-element antennas 1441 and single-element antennas 1442 of FIG. 14A, in accordance with some demonstrative aspects.

For example, antenna array 1010 (FIG. 10) may include one or more elements of antenna array 1410, and/or may perform one or more operations and/or functionalities of antenna array 1410.

In some demonstrative aspects, antenna array 1410 may include one or more elements of first Tx array 1142 (FIG. 11) and/or second Tx array 1144 (FIG. 11), and/or may perform one or more operations and/or functionalities of first Tx array 1142 (FIG. 11) and/or second Tx array 1144 (FIG. 11).

In some demonstrative aspects, a transmission controller, e.g., transmission controller 1024 (FIG. 10), may be configured to generate control signals, e.g., control signals 1025 (FIG. 10), to control a plurality of multi-element transmissions 1431 via the plurality of multi-element antennas 1441 of antenna array 1410, and one or more single-element transmissions 1432 via one or more single-element antennas 1442, for example, according to the multi-element transmission scheme 1400.

In some demonstrative aspects, a single-element antenna 1442 of the antenna array 1410 may include a single antenna element of the antenna array 1110 (FIG. 11).

In some demonstrative aspects, the one or more single-element antennas 1442 may include one or more edge antenna elements at one or more ends of the antenna array 1442.

In one example, a single-element antenna 1443 may include an antenna element #1 of the antenna array 1410.

In one example, a single-element antenna 1445 may include an antenna element #2 of the antenna array 1410.

In one example, a single-element antenna 1447 may include an antenna element #15 of the antenna array 1410.

In one example, single-element antenna 1449 may include an antenna element #16 of the antenna array 1410.

In some demonstrative aspects, a single-element transmission 1432, e.g., each single-element transmission 1432, via a respective single-element antenna 1442, may include a transmission via an edge antenna element of the antenna array 1110 (FIG. 11).

For example, as shown in FIG. 14B, a single-element transmission 1432 via the single-element antenna 1443 may include a transmission via the antenna element #1.

For example, as shown in FIG. 14B, a single-element transmission 1432 via the single-element antenna 1445 may include a transmission via the antenna element #2.

For example, as shown in FIG. 14B, a single-element transmission 1432 via the single-element antenna 1447 may include a transmission via the antenna element #15.

For example, as shown in FIG. 14B, a single-element transmission 1432 via the single-element antenna 1449 may include a transmission via the antenna element #16.

In some demonstrative aspects, a multi-element antenna 1452, e.g., of the plurality of multi-element antennas 1441, may include two or more adjacent antenna elements of the antenna array 1410.

In some demonstrative aspects, the multi-element antenna 1452 may include a dual-element antenna 1452 including two adjacent antenna elements of the antenna array 1410.

In one example, the dual-element antenna 1452 may include the antenna element #1 and the antenna element #3 of the antenna array 1410.

In some demonstrative aspects, the multi-element transmission scheme 1400 may be configured to improve, e.g., maximize, the utilization of the antenna array 1110 (FIG. 11).

In some demonstrative aspects, the multi-element transmission scheme 1400 may be configured according to a hybrid allocation, for example, where the edge (external) pads of the antenna array, e.g., Tx #1, Tx #2, Tx #15, and/or Tx #16, may transmit separately, for example, similar to the single-element transmission scheme 1200 (FIG. 12).

In some demonstrative aspects, the multi-element transmission scheme 1400 may be configured to provide a technical solution to support an improved Tx efficiency, for example, compared to a Tx efficiency of multi-element transmission scheme 1300 (FIG. 13B).

For example, in a multi-mode PRI 1477 including 37 time slots, there may be 28 full transmissions from 28 multi-element virtual elements, e.g., Tx from dual-elements, and 4 “half transmissions” 1432 from 4 single elements 1442, e.g., Tx from one element.

In some demonstrative aspects, the multi-element transmission scheme 1400 may be configured to provide a technical solution to support an increased aperture, for example, as multi-element transmission scheme 1400 may provide a virtual antenna array 1418 including 16 virtual dual-elements, which may be uniformly spaced, for example, based on antenna array 1110 (FIG. 11).

In some demonstrative aspects, the multi-element transmission scheme 1400 may be configured to provide a technical solution to activate 4 transmitters for the 4 “half transmissions” 1432 from the 4 single element antennas 1442. For example, the multi-element transmission scheme 1400 may utilize the fact that in a certain timeslot where the system still waits for a certain Tx to transmit, there may be other Tx chains that are free to transmit.

In one example, in slot #9, the Tx #5 may still be occupied with a previous transmission from multi-element antenna “5+7”, for example, similar to the situation described above with respect to multi-element transmission scheme 1300 (FIG. 13B). However, when implementing multi-element transmission scheme 1400, it may be possible to transmit the single-element transmission 1432 in slot #9, for example, via Tx #1, which may be free to transmit.

In some demonstrative aspects, the multi-element transmission scheme 1400 may have a link budget with an improvement, e.g., compared to the baseline of single-element transmission scheme 1200 (FIG. 12).

In some demonstrative aspects, this improvement in the link budget may be achieved, for example, even without changing the hardware, e.g., using the same antenna elements of antenna array 1110 (FIG. 11), and/or even without changing the element spacing of antenna array 1110 (FIG. 11), for example, to provide a same ambiguity behavior.

In some demonstrative aspects, the multi-element transmission scheme 1400 may be implemented to provide a technical solution to support narrowing a Tx FoV of an antenna array, e.g., antenna array 1110 (FIG. 11), for example, by a factor of two, e.g., compared to a FoV provided by the single-mode transmission scheme 1200 (FIG. 12).

In some demonstrative aspects, the overall FoV of antenna array 1110 (FIG. 11) according to the multi-element transmission scheme 1400 may be narrowed down by a factor of approximately 1.5, for example, since an Rx FoV may remain substantially the same in all transmission modes.

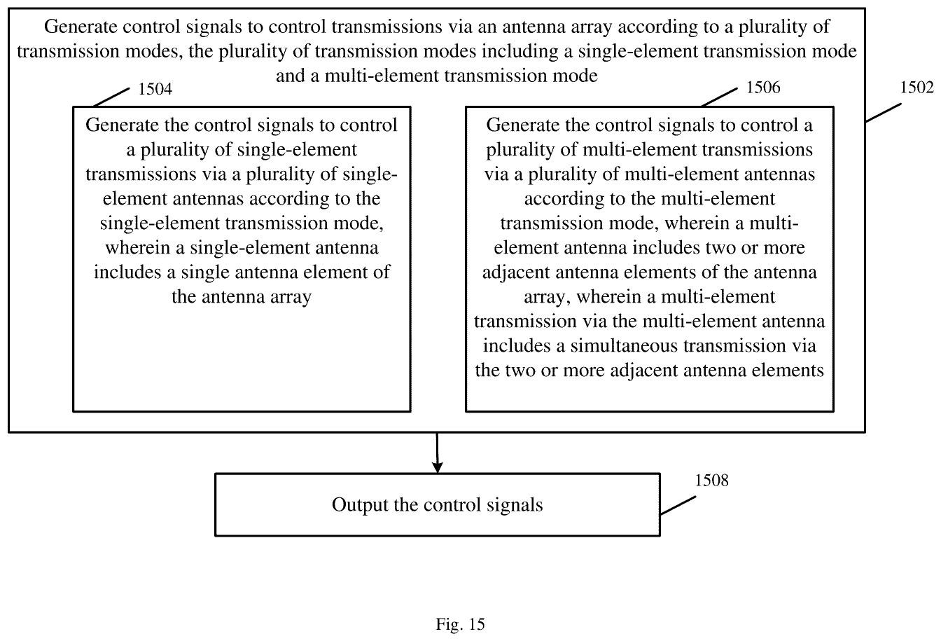

Reference is made to FIG. 15, which schematically illustrates a method of a multi-mode transmission, in accordance with some demonstrative aspects. For example, one or more of the operations of the method of FIG. 15 may be performed by a system, e.g., radar system 900 (FIG. 9), and/or system 1000 (FIG. 10), a radar device, e.g., radar device 101 (FIG. 1), radar device 800 (FIG. 8), and/or radar device 910 (FIG. 9); a controller, e.g., controller 1020 (FIG. 10), a transmission controller, e.g., transmission controller 1024 (FIG. 10), and/or a processor, e.g., radar processor 834 (FIG. 8), and/or baseband processor 930 (FIG. 9).

As indicated at block 1502, the method may include generating control signals to control transmissions via an antenna array according to a plurality of transmission modes. For example, the plurality of transmission modes may include a single-element transmission mode and a multi-element transmission mode. For example, transmission controller 1024 (FIG. 10) may be configured to generate control signals 1025 (FIG. 10) to control the plurality of transmission modes, e.g., as described above.

As indicated at block 1504, generating the control signals to control the transmissions via the antenna array may include generating the control signals to control a plurality of single-element transmissions via a plurality of single-element antennas according to the single-element transmission mode. For example, a single-element antenna may include a single antenna element of the antenna array. For example, transmission controller 1024 (FIG. 10) may be configured to generate the control signals 1025 (FIG. 10) to control the plurality of single-element transmissions 1035 (FIG. 10) via the plurality of single-element antennas 1031 (FIG. 10) according to the single-element transmission mode 1030 (FIG. 10), e.g., as described above.

As indicated at block 1506, generating the control signals to control the transmissions via the antenna array may include generating the control signals to control a plurality of multi-element transmissions via a plurality of multi-element antennas according to the multi-element transmission mode. For example, a multi-element antenna may include two or more adjacent antenna elements of the antenna array. For example, a multi-element transmission via the multi-element antenna may include a simultaneous transmission via the two or more adjacent antenna elements. For example, transmission controller 1024 (FIG. 10) may be configured to generate the control signals 1025 (FIG. 10) to control the plurality of multi-element transmissions 1045 (FIG. 10) via the plurality of multi-element antennas 1041 (FIG. 10) according to the multi-element transmission mode 1040 (FIG. 10), e.g., as described above.

As indicated at block 1508, the method may include outputting the control signals. For example, transmission controller 1024 (FIG. 10) may be configured to provide the control signals 1025 (FIG. 10), for example, via output 1026 (FIG. 10), e.g., as described above.

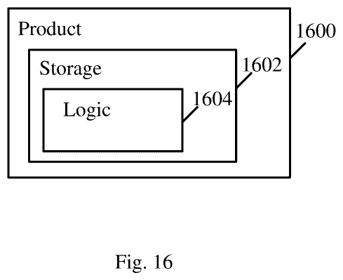

Reference is made to FIG. 16, which schematically illustrates a product of manufacture 1600, in accordance with some demonstrative aspects. Product 1600 may include one or more tangible computer-readable (“machine-readable”) non-transitory storage media 1602, which may include computer-executable instructions, e.g., implemented by logic 1604, operable to, when executed by at least one computer processor, enable the at least one computer processor to implement one or more operations and/or functionalities described with reference to any of the FIGS. 1-15, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1600 and/or machine-readable storage media 1602 may include one or more types of computer-readable storage media capable of storing data, including volatile memory, non-volatile memory, removable or non-removable memory, erasable or non-erasable memory, writeable or re-writeable memory, and the like. For example, machine-readable storage media 1602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a transmission controller configured to generate control signals to control transmissions via an antenna array according to a plurality of transmission modes, the plurality of transmission modes comprising a single-element transmission mode and a multi-element transmission mode, wherein the single-element transmission mode comprises a plurality of single-element transmissions via a plurality of single-element antennas, wherein a single-element antenna comprises a single antenna element of the antenna array, wherein the multi-element transmission mode comprises a plurality of multi-element transmissions via a plurality of multi-element antennas, wherein a multi-element antenna comprises two or more adjacent antenna elements of the antenna array, wherein a multi-element transmission via the multi-element antenna comprises a simultaneous transmission via the two or more adjacent antenna elements; and an output to provide the control signals.

Example 2 includes the subject matter of Example 1, and optionally, wherein the transmission controller is configured to generate the control signals to control the multi-element transmission via the multi-element antenna such that the simultaneous transmission via the two or more adjacent antenna elements of the multi-element antenna is to form a combined signal from a virtual antenna element, wherein the combined signal is based on a combination of two or more signals via the two or more adjacent antenna elements, wherein the virtual antenna element is based on a combination of the two or more adjacent antenna elements.

Example 3 includes the subject matter of Example 2, and optionally, wherein an area of the virtual antenna element is based on a sum of areas of the two or more adjacent antenna elements.

Example 4 includes the subject matter of Example 2 or 3, and optionally, wherein a center of the virtual antenna element is based on centers of the two or more adjacent antenna elements.

Example 5 includes the subject matter of any one of Examples 2-4, and optionally, wherein a radiation pattern of the virtual antenna element is based on element radiation patterns of the two or more adjacent antenna elements.

Example 6 includes the subject matter of any one of Examples 1-5, and optionally, wherein the simultaneous transmission via the two or more adjacent antenna elements comprises a simultaneous transmission of two or more signals via the two or more adjacent antenna elements, respectively.

Example 7 includes the subject matter of Example 6, and optionally, wherein the transmission controller is configured to generate the control signals to control the transmission of the two or more signals to start at substantially a same start time and to end at substantially a same end time.

Example 8 includes the subject matter of Example 6 or 7, and optionally, wherein the two or more signals are substantially coherent.

Example 9 includes the subject matter of any one of Examples 6-8, and optionally, wherein the two or more signals comprise a same signal.

Example 10 includes the subject matter of any one of Examples 1-9, and optionally, wherein the plurality of multi-element antennas comprises a first multi-element antenna and a second multi-element antenna, wherein the first multi-element antenna comprises two or more first adjacent antenna elements of the antenna array, wherein the second multi-element antenna comprises two or more second adjacent antenna elements of the antenna array.

Example 11 includes the subject matter of Example 10, and optionally, wherein at least one antenna element in the two or more first adjacent antenna elements is not included in the two or more second adjacent antenna elements.

Example 12 includes the subject matter of Example 10 or 11, and optionally, wherein each antenna element in the two or more first adjacent antenna elements is not included in the two or more second adjacent antenna elements.

Example 13 includes the subject matter of any one of Examples 10-12, and optionally, wherein at least one antenna element in the two or more second adjacent antenna elements is not included in the two or more first adjacent antenna elements.

Example 14 includes the subject matter of any one of Examples 10-13, and optionally, wherein each antenna element in the two or more second adjacent antenna elements is not included in the two or more first adjacent antenna elements.

Example 15 includes the subject matter of any one of Examples 1-14, and optionally, wherein the transmission controller is configured to generate the control signals to control a staggered transmission of the plurality of multi-element transmissions during a multi-element mode Pulse Repetition Interval (PRI) comprising a sequence of multi-element mode time slots, wherein the staggered transmission of the plurality of multi-element transmissions is configured such that the plurality of multi-element transmissions start at a plurality of staggered multi-element mode start times, respectively, wherein the plurality of staggered multi-element mode start times are in a respective plurality of multi-element mode time slots of the sequence of multi-element mode time slots.

Example 16 includes the subject matter of Example 15, and optionally, wherein the transmission controller is configured to generate the control signals to control a staggered transmission of the plurality of single-element transmissions during a single-element mode PRI comprising a sequence of single-element mode time slots, wherein the staggered transmission of the plurality of single-element transmissions is configured such that the plurality of single-element transmissions start at a plurality of staggered single-element mode start times, respectively, wherein the plurality of staggered single-element mode start times are in a respective plurality of single-element mode time slots of the sequence of single-element mode time slots.

Example 17 includes the subject matter of Example 16, and optionally, wherein a duration of each of the plurality of multi-element mode time slots is substantially equal to a duration of each of the plurality of single-element mode time slots.

Example 18 includes the subject matter of any one of Examples 1-17, and optionally, wherein the plurality of multi-element transmissions comprises a first plurality of multi-element transmissions and a second plurality of multi-element transmissions, wherein the first plurality of multi-element transmissions are via a first plurality of multi-element antennas of a first sub-array of the antenna array, wherein the second plurality of multi-element transmissions are via a second plurality of multi-element antennas of a second sub-array of the antenna array.

Example 19 includes the subject matter of Example 18, and optionally, wherein the first plurality of multi-element transmissions comprises a first plurality of first-sub-array multi-element transmissions via a first plurality of first-sub-array multi-element antennas of the first sub-array, and a second plurality of first-sub-array multi-element transmissions via a second plurality of first-sub-array multi-element antennas of the first sub-array, wherein the second plurality of multi-element transmissions comprises a first plurality of second-sub-array multi-element transmissions via a first plurality of second-sub-array multi-element antennas of the second sub-array, and a second plurality of second-sub-array multi-element transmissions via a second plurality of second-sub-array multi-element antennas of the second sub-array.

Example 20 includes the subject matter of Example 19, and optionally, wherein at least one multi-element antenna of the first plurality of first-sub-array multi-element antennas comprises at least one same antenna element of a respective multi-element antenna of the second plurality of first-sub-array multi-element antennas, wherein at least one multi-element antenna of the first plurality of second-sub-array multi-element antennas comprises at least one same antenna element of a respective multi-element antenna of the second plurality of second-sub-array multi-element antennas.

Example 21 includes the subject matter of Example 19 or 20, and optionally, wherein each multi-element antenna of the first plurality of first-sub-array multi-element antennas comprises at least one same antenna element of a respective multi-element antenna of the second plurality of first-sub-array multi-element antennas, wherein each multi-element antenna of the first plurality of second-sub-array multi-element antennas comprises at least one same antenna element of a respective multi-element antenna of the second plurality of second-sub-array multi-element antennas.

Example 22 includes the subject matter of any one of Examples 18-21, and optionally, wherein the first sub-array and the second sub-array are arranged in a staggered arrangement such that antenna elements of the second sub-array are staggered with respect to antenna elements of the first sub-array.

Example 23 includes the subject matter of any one of Examples 18-22, and optionally, wherein a multi-element antenna of the first plurality of multi-element antennas comprises two or more adjacent antenna elements of the first sub-array, wherein a multi-element antenna of the second plurality of multi-element antennas comprises two or more adjacent antenna elements of the second sub-array.

Example 24 includes the subject matter of any one of Examples 18-23, and optionally, wherein the plurality of single-element transmissions comprises a first plurality of single-element transmissions and a second plurality of single-element transmissions, wherein the first plurality of single-element transmissions are via a first plurality of single-element antennas of the first sub-array, wherein the second plurality of single-element transmissions are via a second plurality of single-element antennas of the second sub-array.

Example 25 includes the subject matter of any one of Examples 1-24, and optionally, wherein a duration of the multi-element transmission via the multi-element antenna is based on a duration of a single-element transmission of the plurality of single-element transmissions and on a count of the two or more adjacent antenna elements of the multi-element antenna.

Example 26 includes the subject matter of any one of Examples 1-25, and optionally, wherein the transmission controller is configured to generate the control signals to control a plurality of Power Amplifiers (PAs) to amplify a first plurality of multi-element transmissions via a first plurality of multi-element antennas of a first sub-array of the antenna array, and to switch the plurality of PAs to amplify a second plurality of multi-element transmissions via a second plurality of multi-element antennas of a second sub-array of the antenna array.

Example 27 includes the subject matter of any one of Examples 1-26, and optionally, wherein the transmission controller is configured to generate the control signals to control a plurality of Power Amplifiers (PAs) to amplify a first plurality of single-element transmissions via a first plurality of single-element antennas of a first sub-array of the antenna array, and to switch the plurality of PAs to amplify a second plurality of single-element transmissions via a second plurality of single-element antennas of a second sub-array of the antenna array.

Example 28 includes the subject matter of any one of Examples 1-27, and optionally, wherein the multi-element transmission mode comprises one or more single-element transmissions via one or more single-element antennas for the multi-element transmission mode.

Example 29 includes the subject matter of Example 28, and optionally, wherein the one or more single-element antennas for the multi-element transmission mode comprises one or more edge antenna elements at one or more ends of the antenna array.

Example 30 includes the subject matter of any one of Examples 1-29, and optionally, wherein the plurality of multi-element antennas is configured to form a virtual uniform Transmit (Tx) antenna array having a uniform spacing between virtual antenna elements of the virtual uniform Tx antenna array.

Example 31 includes the subject matter of any one of Examples 1-30, and optionally, wherein the transmission controller is configured to generate the control signals to control the multi-element transmission via the multi-element antenna to form a multi-element radiation pattern of the multi-element antenna, wherein the multi-element radiation pattern of the multi-element antenna is based on a combination of element radiation patterns of the two or more adjacent antenna elements of the multi-element antenna.

Example 32 includes the subject matter of Example 31, and optionally, wherein the multi-element radiation pattern of the multi-element antenna is different from a single-element radiation pattern of the single-element antenna.

Example 33 includes the subject matter of Example 31 or 32, and optionally, wherein the multi-element radiation pattern of the multi-element antenna is narrower than a single-element radiation pattern of the single-element antenna.

Example 34 includes the subject matter of any one of Examples 1-33, and optionally, wherein the transmission controller is configured to generate the control signals to control the plurality of single-element transmissions according to the single-element transmission mode to cover a first Field of View (FoV) of the antenna array, wherein the transmission controller is configured to generate the control signals to control the plurality of single-element transmissions according to the multi-element transmission mode to cover a second FoV of the antenna array, wherein the second FoV is different from the first FoV.

Example 35 includes the subject matter of Example 34, and optionally, wherein the second FoV is narrower than the first FoV.

Example 36 includes the subject matter of Example 34 or 35, and optionally, wherein the second FoV is less than 70% of the first FoV.

Example 37 includes the subject matter of any one of Examples 1-36, and optionally, wherein the transmission controller is configured to identify a selected transmission mode from the plurality of transmission modes, and to generate the control signals to control the transmissions via the antenna array according to the selected transmission mode.

Example 38 includes the subject matter of any one of Examples 1-37, and optionally, wherein the multi-element transmission mode comprises a plurality of pulses repeated in a plurality of multi-element mode Pulse Repetition Intervals (PRIs), wherein a pulse comprises the plurality of multi-element transmissions via the plurality of multi-element antennas.

Example 39 includes the subject matter of any one of Examples 1-38, and optionally, wherein the single-element transmission mode comprises a plurality of pulses repeated in a plurality of single-element mode Pulse Repetition Intervals (PRIs), wherein a pulse comprises the plurality of single-element transmissions via the plurality of single-element antennas.

Example 40 includes the subject matter of any one of Examples 1-39, and optionally, wherein the plurality of multi-element transmissions via the plurality of multi-element antennas comprises a plurality of dual-element transmissions via a plurality of dual-element antennas, wherein a dual-element antenna comprises two adjacent antenna elements of the antenna array.

Example 41 includes the subject matter of any one of Examples 1-40, and optionally, comprising a radar device, the radar device comprising a Transmit (Tx) array to transmit radar Tx signals, and a receive (Rx) array comprising a plurality of Rx antennas to receive radar Rx signals based on the radar Tx signals, wherein the Tx array comprises the antenna array.

Example 42 includes the subject matter of Example 41, and optionally, comprising a radar processor configured to generate radar information based on the Radar Rx signals.

Example 43 includes the subject matter of Example 42, and optionally, comprising a vehicle, the vehicle comprising the radar device, and a system controller to control one or more systems of the vehicle based on the radar information.

Example 44 includes a radar system comprising the subject matter of any of Examples 1-42.

Example 45 includes a vehicle comprising the subject matter of any of Examples 1-42.

Example 46 includes an apparatus comprising means for performing any of the described operations of any of Examples 1-42.

Example 47 includes a machine-readable medium that stores instructions for execution by a processor to perform any of the described operations of any of Examples 1-42.

Example 48 comprises a product comprising one or more tangible computer-readable non-transitory storage media comprising instructions operable to, when executed by at least one processor, enable the at least one processor to cause a device and/or system to perform any of the described operations of any of Examples 1-42.

Example 49 includes an apparatus comprising a memory; and processing circuitry configured to perform any of the described operations of any of Examples 1-42.

Example 50 includes a method including any of the described operations of any of Examples 1-42.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a transmission controller configured to generate control signals to control transmissions via an antenna array according to a plurality of transmission modes, the plurality of transmission modes comprising a single-element transmission mode and a multi-element transmission mode, wherein the single-element transmission mode comprises a plurality of single-element transmissions via a plurality of single-element antennas, wherein a single-element antenna comprises a single antenna element of the antenna array, wherein the multi-element transmission mode comprises a plurality of multi-element transmissions via a plurality of multi-element antennas, wherein a multi-element antenna comprises two or more adjacent antenna elements of the antenna array, wherein a multi-element transmission via the multi-element antenna comprises a simultaneous transmission via the two or more adjacent antenna elements; and
an output to provide the control signals.

2. The apparatus of claim 1, wherein the transmission controller is configured to generate the control signals to control the multi-element transmission via the multi-element antenna such that the simultaneous transmission via the two or more adjacent antenna elements of the multi-element antenna is to form a combined signal from a virtual antenna element, wherein the combined signal is based on a combination of two or more signals via the two or more adjacent antenna elements, wherein the virtual antenna element is based on a combination of the two or more adjacent antenna elements.

3. The apparatus of claim 1, wherein the simultaneous transmission via the two or more adjacent antenna elements comprises a simultaneous transmission of two or more signals via the two or more adjacent antenna elements, respectively.

4. The apparatus of claim 3, wherein the transmission controller is configured to generate the control signals to control the transmission of the two or more signals to start at substantially a same start time and to end at substantially a same end time.

5. The apparatus of claim 1, wherein the plurality of multi-element antennas comprises a first multi-element antenna and a second multi-element antenna, wherein the first multi-element antenna comprises two or more first adjacent antenna elements of the antenna array, wherein the second multi-element antenna comprises two or more second adjacent antenna elements of the antenna array.

6. The apparatus of claim 5, wherein at least one antenna element in the two or more first adjacent antenna elements is not included in the two or more second adjacent antenna elements.

7. The apparatus of claim 5, wherein each antenna element in the two or more first adjacent antenna elements is not included in the two or more second adjacent antenna elements.

8. The apparatus of claim 7, wherein at least one antenna element in the two or more second adjacent antenna elements is not included in the two or more first adjacent antenna elements.

9. The apparatus of claim 1, wherein the transmission controller is configured to generate the control signals to control a staggered transmission of the plurality of multi-element transmissions during a multi-element mode Pulse Repetition Interval (PRI) comprising a sequence of multi-element mode time slots, wherein the staggered transmission of the plurality of multi-element transmissions is configured such that the plurality of multi-element transmissions start at a plurality of staggered multi-element mode start times, respectively, wherein the plurality of staggered multi-element mode start times are in a respective plurality of multi-element mode time slots of the sequence of multi-element mode time slots.

10. The apparatus of claim 9, wherein the transmission controller is configured to generate the control signals to control a staggered transmission of the plurality of single-element transmissions during a single-element mode PRI comprising a sequence of single-element mode time slots, wherein the staggered transmission of the plurality of single-element transmissions is configured such that the plurality of single-element transmissions start at a plurality of staggered single-element mode start times, respectively, wherein the plurality of staggered single-element mode start times are in a respective plurality of single-element mode time slots of the sequence of single-element mode time slots.

11. The apparatus of claim 1, wherein the plurality of multi-element transmissions comprises a first plurality of multi-element transmissions and a second plurality of multi-element transmissions, wherein the first plurality of multi-element transmissions are via a first plurality of multi-element antennas of a first sub-array of the antenna array, wherein the second plurality of multi-element transmissions are via a second plurality of multi-element antennas of a second sub-array of the antenna array.

12. The apparatus of claim 11, wherein the first plurality of multi-element transmissions comprises a first plurality of first-sub-array multi-element transmissions via a first plurality of first-sub-array multi-element antennas of the first sub-array, and a second plurality of first-sub-array multi-element transmissions via a second plurality of first-sub-array multi-element antennas of the first sub-array, wherein the second plurality of multi-element transmissions comprises a first plurality of second-sub-array multi-element transmissions via a first plurality of second-sub-array multi-element antennas of the second sub-array, and a second plurality of second-sub-array multi-element transmissions via a second plurality of second-sub-array multi-element antennas of the second sub-array.

13. The apparatus of claim 12, wherein at least one multi-element antenna of the first plurality of first-sub-array multi-element antennas comprises at least one same antenna element of a respective multi-element antenna of the second plurality of first-sub-array multi-element antennas, wherein at least one multi-element antenna of the first plurality of second-sub-array multi-element antennas comprises at least one same antenna element of a respective multi-element antenna of the second plurality of second-sub-array multi-element antennas.

14. The apparatus of claim 11, wherein the first sub-array and the second sub-array are arranged in a staggered arrangement such that antenna elements of the second sub-array are staggered with respect to antenna elements of the first sub-array.

15. The apparatus of claim 11, wherein a multi-element antenna of the first plurality of multi-element antennas comprises two or more adjacent antenna elements of the first sub-array, wherein a multi-element antenna of the second plurality of multi-element antennas comprises two or more adjacent antenna elements of the second sub-array.

16. The apparatus of claim 11, wherein the plurality of single-element transmissions comprises a first plurality of single-element transmissions and a second plurality of single-element transmissions, wherein the first plurality of single-element transmissions are via a first plurality of single-element antennas of the first sub-array, wherein the second plurality of single-element transmissions are via a second plurality of single-element antennas of the second sub-array.

17. The apparatus of claim 1, wherein a duration of the multi-element transmission via the multi-element antenna is based on a duration of a single-element transmission of the plurality of single-element transmissions and on a count of the two or more adjacent antenna elements of the multi-element antenna.

18. The apparatus of claim 1, wherein the transmission controller is configured to generate the control signals to control a plurality of Power Amplifiers (PAs) to amplify a first plurality of multi-element transmissions via a first plurality of multi-element antennas of a first sub-array of the antenna array, and to switch the plurality of PAs to amplify a second plurality of multi-element transmissions via a second plurality of multi-element antennas of a second sub-array of the antenna array.

19. The apparatus of claim 1, wherein the multi-element transmission mode comprises one or more single-element transmissions via one or more single-element antennas for the multi-element transmission mode, wherein the one or more single-element antennas for the multi-element transmission mode comprises one or more edge antenna elements at one or more ends of the antenna array.

20. The apparatus of claim 1, wherein the transmission controller is configured to generate the control signals to control the multi-element transmission via the multi-element antenna to form a multi-element radiation pattern of the multi-element antenna, wherein the multi-element radiation pattern of the multi-element antenna is based on a combination of element radiation patterns of the two or more adjacent antenna elements of the multi-element antenna, wherein the multi-element radiation pattern of the multi-element antenna is narrower than a single-element radiation pattern of the single-element antenna.

21. The apparatus of claim 1, wherein the transmission controller is configured to generate the control signals to control the plurality of single-element transmissions according to the single-element transmission mode to cover a first Field of View (FoV) of the antenna array, wherein the transmission controller is configured to generate the control signals to control the plurality of single-element transmissions according to the multi-element transmission mode to cover a second FoV of the antenna array, wherein the second FoV is different from the first FoV.

22. The apparatus of claim 1, wherein the plurality of multi-element transmissions via the plurality of multi-element antennas comprises a plurality of dual-element transmissions via a plurality of dual-element antennas, wherein a dual-element antenna comprises two adjacent antenna elements of the antenna array.

23. The apparatus of claim 1 comprising a radar device, the radar device comprising:
a Transmit (Tx) array to transmit radar Tx signals;
a receive (Rx) array comprising a plurality of Rx antennas to receive radar Rx signals based on the radar Tx signals, wherein the Tx array comprises the antenna array; and
a radar processor configured to generate radar information based on the radar Rx signals.

24. A product comprising one or more tangible computer-readable non-transitory storage media comprising instructions operable to, when executed by at least one processor, enable the at least one processor to cause a transmission controller to:
generate control signals to control transmissions via an antenna array according to a plurality of transmission modes, the plurality of transmission modes comprising a single-element transmission mode and a multi-element transmission mode, wherein the single-element transmission mode comprises a plurality of single-element transmissions via a plurality of single-element antennas, wherein a single-element antenna comprises a single antenna element of the antenna array, wherein the multi-element transmission mode comprises a plurality of multi-element transmissions via a plurality of multi-element antennas, wherein a multi-element antenna comprises two or more adjacent antenna elements of the antenna array, wherein a multi-element transmission via the multi-element antenna comprises a simultaneous transmission via the two or more adjacent antenna elements; and
output the control signals.

25. The product of claim 24, wherein the instructions, when executed, cause the transmission controller to generate the control signals to:
control a plurality of Power Amplifiers (PAs) to amplify a first plurality of multi-element transmissions via a first plurality of multi-element antennas of a first sub-array of the antenna array; and
switch the plurality of PAs to amplify a second plurality of multi-element transmissions via a second plurality of multi-element antennas of a second sub-array of the antenna array.
